(19) United States
(12) Patent Application Publication
(10) Pub. No.: US 2013/0252657 A1
(43) Pub. Date: Sep. 26, 2013

(54) METHOD, APPARATUS, AND COMPUTER PROGRAM PRODUCT FOR TRANSMIT POWER MANAGEMENT AND LOCATION INFORMATION ESTIMATION

(71) Applicant: Padam Lal KAFLE, Coppell, TX (US)

(72) Inventor: Padam Lal KAFLE, Coppell, TX (US)

(73) Assignee: NOKIA CORPORATION, Espoo (FI)

(21) Appl. No.: 13/428,824

(22) Filed: Mar. 23, 2012

(51) Int. Cl. H04W 52/32

(52) U.S. Cl. 455/522

(57) ABSTRACT

Method, apparatus, and computer program product embodiments of the invention are disclosed for transmit power management and location information estimation employable, for example, in operation in TV white spaces. In example embodiments of the invention, a method comprises: obtaining, at a white space device, a plurality of managed white space device regulatory maximum transmit power levels; calculating, at the white space device, a plurality of managed white space device local maximum transmit power levels; determining to transmit, from the white space device, the calculated plurality of managed white space device local maximum transmit power levels; and performing, at the white space device, one or more of: administrating one or more managed white space device power protection rules; setting a managed white space device default transmit power level; and rejecting managed white space device association and/or enablement.

### FIELD

The field of the invention relates to transmit power management and location information estimation employed, for example, for operation in TV white spaces.

### BACKGROUND

Use of radio frequency bands of the electromagnetic spectrum is regulated by governments in most countries, by allocating specific frequency bands to particular types of uses, such as licensed bands for commercial radio and television broadcasting, cellular telephony, mobile networks such as CDMA2000, WCDMA, HSPA, LTE, and IMT, maritime radio, police, fire, and public safety radio, GPS, radio astronomy, earth stations for satellite communications, and many other uses. Governments also allocate unlicensed bands, for example, for Wireless Regional Area Network (WRAN) broadband access for rural areas and wireless local area networks (WLAN) and wireless personal area networks (WPAN), such as the industrial, scientific, and medical (ISM) band.

In the United States, the Federal Communications Commission (FCC) regulates use of the radio spectrum, including radio and television broadcasting. Frequencies are allocated according to a bandplan in which guard bands are assigned between the allocated radio bands to avoid interference between adjacent signals. There are also unassigned frequency bands in the spectrum that either have never been used or have become free as a result of changes in technology. Unassigned or un-used frequencies also appear locally inside the frequency bands, which are otherwise allocated in other locations. The unassigned frequency bands and guard bands are referred to as white spaces.

TV white space may be broadly defined as broadcast television spectrum that is unused by licensed services. There are at least two categories of TV white space: Dedicated TV white space is a portion of the spectrum that the FCC has reallocated to unlicensed use from previously analog broadcast usage, and locally unused spectrum by licensed TV broadcasters in a geographic area.

Dedicated TV white space: In the United States, with a federally mandated transformation of analog TV broadcasting to digital TV broadcasting, portions of the broadcast spectrum previously employed for analog TV became unused and were dedicated by the FCC for unlicensed use. However, the FCC has prohibited unlicensed use of white spaces from interfering with existing licensed uses, including digital TV stations, low power TV stations, cable TV headends, and sites where low power wireless microphones are used. Various proposals have been made for unlicensed use of the white spaces left by the termination of analog TV, for example rural broadband deployment, auxiliary public safety communications, educational and enterprise video conferencing, personal consumer applications, mesh networks, security applications, municipal broadband access, enhanced local coverage and communications, fixed backhaul, and sensor aggregation for smart grid meter reading.

Locally unused spectrum by licensed TV broadcasters: The FCC has adopted rules to allow unlicensed radio transmitters to operate in the broadcast television spectrum at locations where that spectrum is not being used by licensed broadcasters. The FCC proposes two mechanisms to enable the unlicensed transmitters to discover the available channels: a geo-location and database based approach which is mandatory for all such devices, and an optional approach based on spectrum sensing capability. The operation under the control of a geo-location based database is called for in connection with the unlicensed transmitter. The FCC proposed the use of geo-location to establish the location of the unlicensed transmitter and a database of TV bands use by licensed broadcasters organized by their geographic coverage areas, to enable the unlicensed transmitter to know where local TV band white spaces may be available. The FCC proposed the use of spectrum sensors in the unlicensed transmitter to optionally detect the presence of the incumbent, primary TV broadcaster's signal in the local TV band to enable the unlicensed transmitter to immediately relinquish using the band. A primary user in such a local TV band would be an incumbent TV broadcaster licensed to operate in that band, but in those geographic areas where there are no licensed incumbent TV broadcasters in operation, other unlicensed secondary users may make use of that band. There may be also other incumbent users in the TV band, which the secondary users should avoid, such as program making and special events (PMSE) systems.

In addition to the United States, other countries are also considering to enable unlicensed, secondary operation in TV band white spaces. The requirements may slightly differ in different countries, e.g. in the United States the maximum transmit power for unlicensed device is defined based on the device type, whereas in Europe location specific maximum transmission power has been considered. In that case the maximum allowed transmission power for an unlicensed device would depend on the device geo-location, i.e. the distance from the primary users. The device characteristics, such as emission mask/ACLR (adjacent channel leakage ratio) may affect the maximum allowed transmission power.

Other RF spectrum white spaces may be defined as RF spectrum that is locally unused in certain geographic areas, such as for example frequency allocations from maritime radio in landlocked areas remote from the sea. A primary user in such a maritime radio band would be a maritime radio licensed to operate in that band, but in those geographic areas where there are no licensed maritime radios in operation, other unlicensed secondary users may make use of that band. Similarly, locally unused spectrum white spaces may be present in certain geographic locations, such as the frequency allocations from 2.025 GHz to 2.110 GHz for earth stations to transmit to communications satellites, in areas remote from such earth stations. A primary user in such a satellite earth station radio band would be a satellite earth station licensed to operate in that band, but in those geographic areas where there are no satellite earth stations in operation, other unlicensed secondary users may make use of that band. Further, other schemes of secondary use of spectrum, other than unlicensed schemes may exist, such as licensing, regulator defined policies, cognitive principles, or authorized shared access.

### SUMMARY

Method, apparatus, and computer program product embodiments of the invention are disclosed for transmit power management and location information estimation employable, for example, in operation in TV white spaces.

In an example embodiment of the invention, a method comprises:

obtaining, at a white space device, a plurality of managed white space device regulatory maximum transmit power levels;

calculating, at the white space device, a plurality of managed white space device local maximum transmit power levels, wherein the calculation takes into account one or more of a plurality of managed white space device power capabilities and a plurality of managed white space device emission mask characteristics;

determining to transmit, from the white space device, the calculated plurality of managed white space device local maximum transmit power levels; and

performing, at the white space device, one or more of:
administrating one or more managed white space device power protection rules;
setting a managed white space device default transmit power level; and
rejecting, based on one or more of the managed white space device regulatory maximum transmit power levels and the managed white space device power capabilities, managed white space device association and/or enablement.

In an example embodiment of the invention, the method further comprises wherein there is a multiple white space device split of management responsibilities relating to transmit power, and wherein the plurality of managed white space device regulatory maximum power transmit levels is received from a plurality of managed white space devices.

In an example embodiment of the invention, the method further comprises wherein the power protection rule administration comprises:

computing a transmit power level threshold; and

mandating managed white space device power protection rule compliance in the case of violation of the threshold.

In an example embodiment of the invention, the method further comprises wherein the power protection rule administration comprises dispatch of a basic service set power map, wherein the basic service set power map includes bits indicating a low power protection category and/or bits indicating a high power protection category.

In an example embodiment of the invention, the method further comprises wherein the power protection rules include low power protection rules and/or high power protection rules.

In an example embodiment of the invention, the method further comprises wherein the managed white space device default transmit power level is employed in one or more of:

initial contact, seeking enablement, with the white space device; and

post expiratory contact, seeking reenablement, with the white space device.

In an example embodiment of the invention, the method further comprises wherein the rejection comprises indicating, using a status code, rejection via an enablement response.

In an example embodiment of the invention, the method further comprises:

estimating, at the white space device, one or more of managed white space device relative range and managed white space device relative direction;

employing, at the white space device, one or more of the estimated relative range and the estimated relative direction in database communication; and

receiving, at the white space device, database indication of managed white space device regulatory parameters.

In an example embodiment of the invention, a method comprises:

determining to transmit, from a managed white space device, device information;

determining to transmit, from the managed white space device, power capability information and/or emission mask characteristics;

receiving, at the managed white space device, a local maximum power transmit level of said managed white space device, wherein the white space device local maximum power transmit level is received via a plurality of managed white space device local maximum power transmit levels, and wherein the plurality of managed white space device local maximum power transmit levels are white space device-calculated;

receiving, at the managed white space device, one or more of:
mandate that the managed white space device use one or more managed white space device power protection rules; and
a default transmit power level; and

operating, at the managed white space device, in accordance with one or more of the local maximum power transmit level of said managed white space device, the mandate, and the default transmit power level.

In an example embodiment of the invention, the method further comprises wherein the device information includes one or more of device identification, technology identifier, device type, location, location accuracy, and antenna characteristics.

In an example embodiment of the invention, the method further comprises wherein the power protection rules include low power protection rules and/or high power protection rules.

In an example embodiment of the invention, the method further comprises:

employing, at the managed white space device, the default transmit power level in one or more of:
initial contact seeking enablement; and
post expiratory contact seeking reenablement.

In an example embodiment of the invention, the method further comprises:

obtaining, at the managed white space device via master white space device communication, a regulatory maximum transmit power level of the managed white space device; and

determining to transmit, from the managed white space device via slave access point white space device communication, the regulatory maximum transmit power level.

In an example embodiment of the invention, an apparatus comprises:

at least one processor; and

at least one memory including computer program code, the at least one memory and the computer program code configured to, with the at least one processor, cause the apparatus at least to perform:

obtain, at the apparatus, a plurality of managed white space device regulatory maximum transmit power levels;

calculate, at the apparatus, a plurality of managed white space device local maximum transmit power levels, wherein the calculation takes into account one or more of a plurality of managed white space device power capabilities and a plurality of managed white space device emission mask characteristics;

determine to transmit, from the apparatus, the calculated plurality of managed white space device local maximum transmit power levels; and

perform, at the apparatus, one or more of:
administrating one or more managed white space device power protection rules;
setting a managed white space device default transmit power level; and
rejecting, based on one or more of the managed white space device regulatory maximum transmit power levels and the managed white space device power capabilities, managed white space device association and/or enablement.

In an example embodiment of the invention, the apparatus further comprises wherein there is a multiple white space device split of management responsibilities relating to transmit power, and wherein the plurality of managed white space device regulatory maximum power transmit levels is received from a plurality of managed white space devices.

In an example embodiment of the invention, the apparatus further comprises wherein the power protection rule administration comprises:

computing a transmit power level threshold; and

mandating managed white space device power protection rule compliance in the case of violation of the threshold.

In an example embodiment of the invention, the apparatus further comprises wherein the power protection rule administration comprises dispatch of a basic service set power map, wherein the basic service set power map includes bits indicating a low power protection category and/or bits indicating a high power protection category.

In an example embodiment of the invention, the apparatus further comprises wherein the power protection rules include low power protection rules and/or high power protection rules.

In an example embodiment of the invention, the apparatus further comprises wherein the managed white space device default transmit power level is employed in one or more of:

initial contact, seeking enablement, with the apparatus; and

post expiratory contact, seeking reenablement, with the apparatus.

In an example embodiment of the invention, the apparatus further comprises wherein the rejection comprises indicating, using a status code, rejection via an enablement response.

In an example embodiment of the invention, the apparatus further comprises wherein the at least one memory and the computer program code are further configured to, with the at least one processor, cause the apparatus to:

estimate, at the apparatus, one or more of managed white space device relative range and managed white space device relative direction;

employ, at the apparatus, one or more of the estimated relative range and the estimated relative direction in database communication; and

receive, at the apparatus, database indication of managed white space device regulatory parameters.

In an example embodiment of the invention, an apparatus comprises:

at least one processor; and

at least one memory including computer program code, the at least one memory and the computer program code configured to, with the at least one processor, cause the apparatus at least to perform:

determine to transmit, from the apparatus, device information;

determine to transmit, from the apparatus, power capability information and/or emission mask characteristics;

receive, at the apparatus, a local maximum power transmit level of said apparatus, wherein the apparatus local maximum power transmit level is received via a plurality of managed white space device local maximum power transmit levels, and wherein the plurality of managed white space device local maximum power transmit levels are white space device-calculated;

receive at the apparatus, one or more of:
mandate that the apparatus use one or more managed white space device power protection rules; and
a default transmit power level; and

operate, at the apparatus, in accordance with one or more of the local maximum power transmit level of said apparatus, the mandate, and the default transmit power level.

In an example embodiment of the invention, the apparatus further comprises wherein the device information includes one or more of device identification, technology identifier, device type, location, location accuracy, and antenna characteristics.

In an example embodiment of the invention, the apparatus further comprises wherein the power protection rules include low power protection rules and/or high power protection rules.

In an example embodiment of the invention, the apparatus further comprises wherein the at least one memory and the computer program code are further configured to, with the at least one processor, cause the apparatus to employ, at the apparatus, the default transmit power level in one or more of:

initial contact seeking enablement; and

post expiratory contact seeking reenablement.

In an example embodiment of the invention, the apparatus further comprises wherein the at least one memory and the computer program code are further configured to, with the at least one processor, cause the apparatus to:

obtain, at the apparatus via master white space device communication, a regulatory maximum transmit power level of the apparatus; and

determine to transmit, from the apparatus via slave access point white space device communication, the regulatory maximum transmit power level.

In an example embodiment of the invention, a computer program product comprising computer executable program code recorded on a computer readable storage medium, the computer executable program code comprising:

code for causing obtainment, at a white space device, of a plurality of managed white space device regulatory maximum transmit power levels;

code for causing calculation, at the white space device, of a plurality of managed white space device local maximum transmit power levels, wherein the calculation takes into account one or more of a plurality of managed white space device power capabilities and a plurality of managed white space device emission mask characteristics;

code for causing determination to transmit, from the white space device, the calculated plurality of managed white space device local maximum transmit power levels; and

code for causing performance, at the white space device, of one or more of:
administration of one or more managed white space device power protection rules;
setting of a managed white space device default transmit power level; and
rejection, based on one or more of the managed white space device regulatory maximum transmit power levels and the managed white space device power capabilities, of managed white space device association and/or enablement.

In an example embodiment of the invention, a computer program product comprising computer executable program code recorded on a computer readable storage medium, the computer executable program code comprising:

code for causing determination to transmit, from a managed white space device, device information;

code for causing determination to transmit, from the managed white space device, power capability information and/or emission mask characteristics;

code for causing receipt, at the managed white space device, of a local maximum power transmit level of said managed white space device, wherein the white space device local maximum power transmit level is received via a plurality of managed white space device local maximum power transmit levels, and wherein the plurality of managed white space device local maximum power transmit levels are white space device-calculated;

code for causing receipt, at the managed white space device, of one or more of:
mandate that the managed white space device use one or more managed white space device power protection rules; and
a default transmit power level; and

code for causing operation, at the managed white space device, in accordance with one or more of the local maximum power transmit level of said managed white space device, the mandate, and the default transmit power level.

In this manner, embodiments of the invention provide transmit power management and location information estimation employable, for example, in operation in TV white spaces.

### DESCRIPTION OF THE FIGURES

FIG. 1 discloses an exemplary network in accordance with at least one example embodiment of the present invention.

FIG. 2 discloses an exemplary deployment scenario for transmit power management functionality in accordance with at least one example embodiment of the present invention.

FIG. 3 discloses an exemplary format for a geo-location database control (GDC) enablement request in accordance with at least one example embodiment of the present invention.

FIG. 4 discloses an exemplary format for a channel availability query frame in accordance with at least one example embodiment of the present invention.

FIG. 5 discloses an exemplary basic service set (BSS) power map information element (IE) in accordance with at least one example embodiment of the present invention.

FIG. 6 discloses an exemplary format for an association and/or reassociation response in accordance with at least one example embodiment of the present invention.

FIG. 7 discloses an exemplary GDC enablement response in accordance with at least one example embodiment of the present invention.

FIG. 8 discloses an exemplary low power protection rule implementation in accordance with at least one example embodiment of the present invention.

FIG. 9 discloses exemplary slave white space device (WSD) transmit power management functionality in accordance with at least one example embodiment of the present invention.

FIG. 10 discloses a possible format for an association and/or reassociation request in accordance with at least one example embodiment of the present invention.

FIG. 11 discloses exemplary location information estimation functionality in accordance with at least one example embodiment of the present invention.

FIG. 12 discloses an exemplary computer in accordance with at least one example embodiment of the present invention.

FIG. 13 discloses an exemplary functional block diagram in accordance with at least one example embodiment of the present invention.

FIG. 14 discloses a further exemplary computer in accordance with at least one example embodiment of the present invention.

### DISCUSSION OF EXAMPLE EMBODIMENTS OF THE INVENTION

### Example Networking Environment

The unlicensed use of white spaces in television (TV) broadcast bands—termed as TV white spaces (TVWS)—is permitted at least in connection with various regulations. As one example, in the United States the Federal Communications Commission (FCC) has released rules for unlicensed operation in such white spaces. As another example, in the United Kingdom the United Kingdom Office of Communications (Ofcom) has released draft requirements for such unlicensed operation.

Such regulations, generally characterized, permit unlicensed wireless devices to operate in regions of the very high frequency (VHF) and/or ultra high frequency (UHF) spectrum bands (e.g., 54 MHz-698 MHz in US) in an opportunistic sharing basis when any of the designated TV channel frequencies are not occupied by the primary users of these spectrum bands. The primary users include licensed TV broadcasters and wireless microphone systems. The amount of TVWS spectrum available for unlicensed use varies substantially based at least on the presence of primary users such as TV broadcasting services and licensed microphone users around the relevant geo-graphic location. In order to achieve goals including enforcing regulatory requirements and protecting services of primary users in the bands, relevant regulations generally call for the use of white space databases/geo-location databases (WSDBs/GDBs). A WSDB/GDB performs operations including providing available channels and other parameters for operation of unlicensed devices and/or networks.

A number of applications take advantage of white spaces. One exemplary application of white spaces is in connection with wireless local area networks (WLANs). The use of white spaces in connection with WLANs yields a number of potential benefits including additional available spectrum and, at least as the VHF band and the lower UHF band provide longer range than is typically possible for WLAN systems in 2.4 or 5 GHz bands, better propagation characteristics.

Institute of Electrical and Electronics Engineers standard IEEE 802.11 of is one exemplary standard for the use of white spaces in connection with WLANs. In addition, exemplary technical requirements and operational frameworks for the use of white spaces in connection with WLANs include those of industry forums such as the Wi-Fi Alliance (WFA) TVWS marketing task group.

Exemplary standard IEEE 802.11 of assumes two types of white space device (WSD) stations (STAs)—enabling STAs and dependent STAs. The functionality of these STAs under the standard generally maps to the FCC model. There is a potential for addition to the standard of aspects based on requirements from other regulations (e.g., Ofcom).

According to the standard, an enabling STA is to have self geo-location capability and should be able to talk to WSDB/GDB to initiate a WLAN network. A dependent STA is assumed to be not capable of self geo-location. Such dependent STA is allowed to operate subsequent to enablement by an enabling STA. The establishment of initial enablement and subsequent control during operation of dependent STAs is provided by using a geo-location database control (GDC) enablement process, a channel availability query process, and a contact verification signal process.

According to the standard, during the GDC enablement process a dependent STA, such as a dependent STA of the FCC Mode I personal/portable device type discussed in greater detail herein, is able to send its device identification information (e.g., FCC ID) for verification and receive list of channels available for its use. The channel availability query procedure from the dependent STA allows for the acquisition of available channel list during operation, with the acquisition providing for maintenance of the validity of an enablement timer. A dependent STA is further required to hear a unicast contact verification signal (CVS) frame at least every 60 s to ensure it is within the coverage area of the enabling STA.

Additionally according to the standard, transmit power control (TPC) procedures allow STAs to report their minimum and/or maximum transmit power capabilities during association and/or reassociation stage so that the corresponding AP is able to calculate the local transmit power level constraint for the basic service set (BSS) it is operating. This local transmit power level is common to all associated STAs. The AP broadcasts the single regulatory power limit in the country element transmitted in its beacon and probe response frames in the channel it is operating. The local transmit power is also advertised in beacon and probe response frames using combination of the country element and power constraint element. In order for a STA to learn about the transmit power limits and link margin for the purpose of adaptation of the transmit power to another STA, one STA is able to send a TPC request frame of a link measurement request frame and receive the TPC report information element (IE) in the response message. The adaptive power control between a pair of STAs by such protocol message exchange also satisfies the regulatory and local power constraints set for the BSS. These TPC procedures were developed for 5 GHz band, and they endeavor to meet the regulatory maximum power limits and mitigation requirements of different sets of channels, which are pre-known for a regulatory domain.

Techniques discussed herein are applicable, for example, in connection with WLAN (e.g., Wi-Fi WLAN) networks and/or devices which operate under the control of a WSDB/GDB within the TVWS spectrum. As additional examples, techniques discussed herein are applicable in connection with the above noted set forth by standards such as IEEE 802.11af and groups such as the WFA.

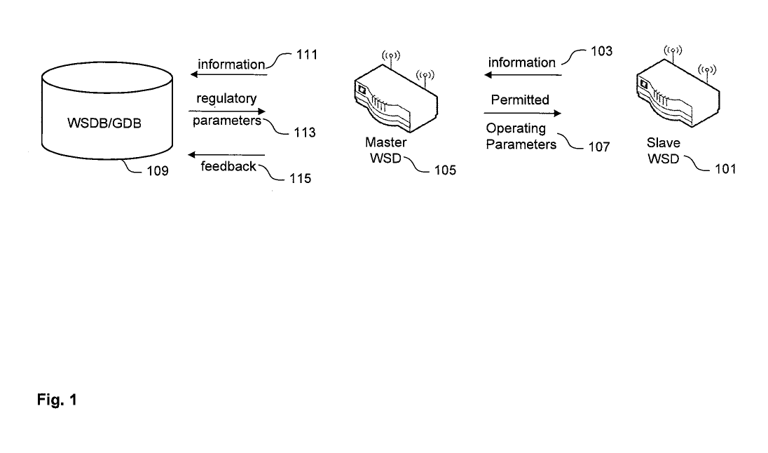

FIG. 1 shows an exemplary network employable in various exemplary embodiments of the present invention discussed herein. According to the example of FIG. 1, slave WSD 101 passes certain information 103 discussed in greater detail herein to master WSD 105 and obtains therefrom permitted operating parameters 107.

Further according to the example of FIG. 1, master WSD 105 passes to WSDB/GDB 109 information 111 and receives in reply regulatory parameters 113. Information 111 includes one or more of information 103 received from slave WSD 101, like information for master WSD 105, and like information received from other slave WSDs managed by master WSD 105. Regulatory parameters 113 include one or more of regulatory parameters for slave WSD 101, regulatory parameters for master WSD 105, and regulatory parameters for other slave WSDs managed by master WSD 105. The regulatory parameters include data such as one or more of available channel list, regulatory maximum transmit power level, time validity information, frequency range, permitted equivalent isotropically radiated power (EIRP) spectral densities, and control commands to cease transmissions.

Additionally according to the example of FIG. 1, as referenced above, master WSD 105 provides permitted operating parameters 107 to slave WSD 101. Moreover, master WSD 105 provides like information to other slave WSDs which it manages. As discussed in greater detail herein, the permitted operating parameters which master WSD 105 passes to slave WSDs include not only regulatory parameters (e.g., regulatory maximum transmit power level) received from WSDB/GDB 109 but also local parameters such as local maximum transmit power level which are determined by master WSD 107. Still further, master WSD 105 employs in its own operation its own regulatory parameters. Moreover, although in FIG. 1 a WSDB and a GDB are shown as single database 109, the white space database WSDB and the GDB are according to an alternative example implemented as separate databases.

Further according to the example of FIG. 1, WSDB/GDB 109 collects usage feedback 115 corresponding to parameters such as actual usage of assigned frequency range and EIRP power spectral densities in that frequency range. Usage feedback 115 includes usage feedback for one or more of master WSD 105, slave WSD 101, and other slave WSDs managed by master WSD 105. WSDB/GDB 109 receives usage feedback 115 from master WSD 105, with master WSD 105 having received usage feedback for slave WSD 101 and other associated slave WSDs from those WSDs. WSDB/GDB 109 employs feedback 115 for purposes including dynamically changing WSD allocated power levels.

It is noted that an alternative term for a slave WSD is “dependent” WSD, and that an alternative term for a master WSD is “enabling” WSD. Further, an alternative term for a WSD is “station” (STA). Additionally, a WSD discussed herein optionally performs acting as an access point (AP) and/or managing one or more other WSDs. Also, the herein discussed management by a first WSD of one or more other WSDs optionally includes the first WSD performing operations whereby those other WSDs are within a BSS (e.g., an 802.11 BSS) of that first WSD.

### Transmit Power Management—General Functionality

Exemplary general transmit power management functionality applicable in handling multiple levels of transmit power constraints will now be discussed. Such functionality is applicable in connection with slave WSDs which are capable of full or partial self geo-location and including the resultant geographic location data among information passed to a master WSD. Such functionality is also applicable in connection with slave WSDs incapable of self geo-location.

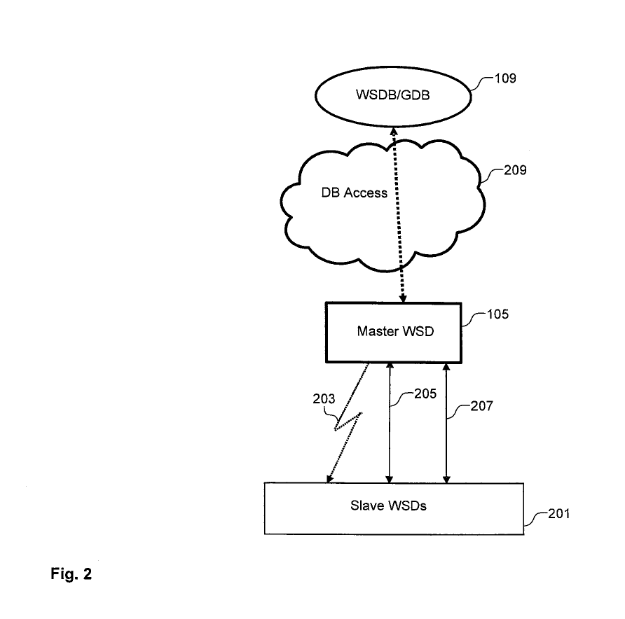

Shown in FIG. 2 is an exemplary deployment scenario for the transmit power management functionality now discussed. According to the example of FIG. 2, master WSD 105 operates as an AP (e.g., an 802.11 AP) which manages maximum transmit power levels for slave WSDs 201. Further shown in FIG. 2 are slave WSDs 201 hearing enabling signal 203, enablement and channel query communications 205 between master WSD 105 and slave WSDs 201, continuance of television white space (TVWS) signal receipt 207 (e.g., in accordance with receipt intervals each of fewer than 5 seconds in duration) by one or more of slave WSDs 201 and master WSD 105, and database access communication 209 between master WSD 105 and WSDB/GDB 109. While FIG. 2 depicts continuance of TVWS signal receipt, TVWS signal receipt, in the alternative or in addition, regards one or more new signals.

Various regulations require strict protection of primary services from unlicensed devices operating in TVWS channels. As one illustrative example, the FCC has categorized three different device types—Fixed, Personal/Portable Mode II and, Personal/Portable Mode I—for specifying operating rules including maximum permitted transmit power levels based on specific device type. Fixed type WSDs are allowed to transmit at 4 W EIRP, whereas personal/portable type WSDs are allowed to transmit at 100 mW EIRP when the device is outside of the protected contour for its corresponding adjacent television channel but only at 40 mW EIRP when being inside the protected contour.

As another illustrative example, in Europe regulations such as those of the Ofcom are taking a more flexible approach for allocating permitted transmit power levels in the TVWS band. Under these regulations the protection ratios necessary for each location and subsequently the permissible transmit power level are computed by a WSDB/GDB for a WSD by utilizing various characteristics and information available about the WSD. Optionally utilized by the WSDB/GDB is technology used by the WSD. Such technology is employable in a fashion that uses a unique technology identifier that is mapable to WSD parameters including one or more of emission mask, waveform characteristics, WSD type (e.g., fixed or portable/mobile), geo-location, antenna position (e.g., indoor versus outdoor), antenna height, antenna polarization, and antenna radiation pattern. The WSDB/GDB is capable of collecting feedback on actual usage of the frequency and EIRP power spectral densities in the used frequency range from the WSDs, allowing the allocated power levels to be changed dynamically.

The flexible model based on elaborate information from the WSDs is usable to improve spectrum utilization by allocating the allowed power level optimally. However, the possibility of assigning different permitted power levels to WSDs such as in a WLAN BSS often increases complexity. There are, generally speaking, two categories of WSD device in Ofcom model, master WSD and slave WSD. A master WSD is able to directly communicate with a WSDB/GDB. A Slave WSD cannot communicate directly to a WSDB/GDB and instead sends certain parameters to its corresponding master WSD.

Under the Ofcom model, all master WSDs self geo-locate (i.e., determine self location coordinates and send that information to a WSDB/GDB), but it is optional for a Slave WSD to have such capability. Still, a slave Ofcom WSD able to self geo-locate and send that information to a Master WSD potentially obtains higher permitted power level from the WSDB/GDB compared to a slave WSD that does not send such information. Under the Ofcom model the WSDB/GDB as a default procedure computes the allocated power for such a slave WSD based on the estimated nominal coverage area for the corresponding master WSD and does so with the most stringent possible location assumed for such slave. As such, under the Ofcom model it is possible in one network to receive a wide range of allocated power for different stations which are permitted until expiration of a specific time validity period.

While the FCC model is arguably less complex than the Ofcom model, the decreased complexity comes at a cost. For example, a network (e.g., a WLAN network) according to the FCC model with pre-known permissible maximum power levels for Fixed or Personal/Portable devices suffers from increased complexity in dealing with hidden stations. Such complexity is often particularly severe when a BSS managed by a low power WSD of FCC type personal/portable mode II overlaps with a BSS managed by a high-power WSD of FCC type fixed.

In contrast to the FCC model, under models such as the Ofcom model transmit power management is more complex with the database model allowing for additional flexibility in allocation of regulatory power limit. Discussed herein are techniques applicable, for instance, in dealing with such models. Such models, for instance, address how a network (e.g., a WLAN network) accommodates multiple levels of transmit power level without severely increasing hidden node problem incidence and/or compromising the network throughput. The hidden node problem is discussed in greater detail below.

More generally, complexity is often introduced as the quantity of maximum transmit power levels which a master WSD needs to manage increases. Such a circumstance arises for a number of reasons. For example, one or more of a master WSD's managed slave WSDs having self geo-location capability often results in the queried WSDB/GDB presenting multiple regulatory maximum transmit power levels for the slave WSDs (e.g., there being a different regulatory maximum transmit power level for each slave WSD) rather than, say, a single regulatory maximum transmit power level being presented for all slave WSDs managed by the master WSD.

As another example, the WSDB/GDB being implemented in such a fashion that regulatory parameter determination takes into account a richer set of WSD parameters often results in the WSDB/GDB presenting multiple regulatory maximum transmit power levels for the slave WSDs rather than, say, a single regulatory maximum transmit power level being presented for all slave WSDs managed by the master WSD. Ofcom regulatory parameter determination, for instance, takes into account such a richer set of WSD parameters. Exemplary members of such a richer set of WSD parameters include one or more of WSD unique technology identifier, WSD emission mask, WSD waveform characteristics, WSD type (e.g., fixed or portable/mobile), WSD geo-location, WSD antenna position (e.g., indoor versus outdoor), WSD antenna height, WSD antenna polarization, and WSD antenna radiation pattern. As such, a WSDB/GDB is able to present multiple regulatory maximum transmit power levels for the slave WSDs even when one or more of those slave WSDs are incapable of self geo-location.

As a further example, the quantity of maximum transmit power levels which a master WSD needs to manage often increases due to there being a higher quantity of local maximum transmit power levels. Situations in which there is such a higher quantity of local maximum transmit power levels include one or more of increased diversity of slave WSD transmit power capabilities and increased quality of regulatory maximum transmit power levels presented by a WSDB/GDB.

The discussed complexity is potentially mitigated by the following transmit power management functionality. Such white space power management potentially yields benefits including meeting requirements directed towards preventing interference to primary users and coordinating coexistence among overlapping networks of greater coverage area compared to legacy WLAN operation.

Transmit Power Management—Master White Space Device (WSD) Functionality

Exemplary master WSD transmit power management functionality applicable in handling multiple levels of transmit power constraints will now be discussed. Such a master WSD potentially operates as an AP or in any other beaconing WSD role (e.g., within the context of a peer-to-peer group owner (P2P GO) or acting as an independent basic service set (IBSS) dynamic frequency selection (DFS) Owner).

As a first illustrative example of such functionality, the master WSD sets the regulatory maximum transmit power level and the local maximum transmit power level for each slave WSD which it manages. The master WSD collects information of permitted maximum regulatory transmit power levels for each of the associated slave WSDs which it manages based on the response from the WSDB/GDB for each slave WSD. Such a slave WSD sends device information such as device identification (e.g., FCC ID in US, or other unique device identifier), technology identifier (e.g., to indicate emission mask category of the device, signal waveform, etc.), type of device, location and/or location accuracy, and/or antenna characteristics during operations such as GDC enablement and/or Channel Availability Query request. The master WSD optionally stores some or all of this information locally. Such local storage potentially allows for avoidance of the need for the master WSD to receive such information from slave WSDs. For instance, the master WSD potentially receives such information from a slave once and then avoids subsequently receiving that information from the slave, or receives such information from the slave only periodically and then avoids subsequently receiving that information from the slave during intervening periods. The local storage is optionally in accordance with requirements such as Ofcom requirements.

Further according to the first illustrative example, the Master WSD passes information of a slave WSD to the WSDB/GDB in order to receive the corresponding operating parameters such as permissible range of frequencies, permissible channels, and/or other parameters. According to one example, for a slave WSD k the operating parameters include a permitted maximum regulatory transmit power level for a channel P_{Reg}^{(k)} (dBm) which is valid for a period Tₘₐₓ^{(k)} (minutes).

Additionally according to the first illustrative example, the master WSD obtains a slave WSD's power capability information. As one alternative such information is received from the slave WSD (e.g., as part of an association request and/or a reassociation request). In addition or as another alternative, the master WSD receives such information from another source such as from local storage. According to one example, for a slave WSD k the minimum and maximum transmit power capabilities are Pₘᵢₙ^{(k)} and Pₘₐₓ^{(k)} respectively.

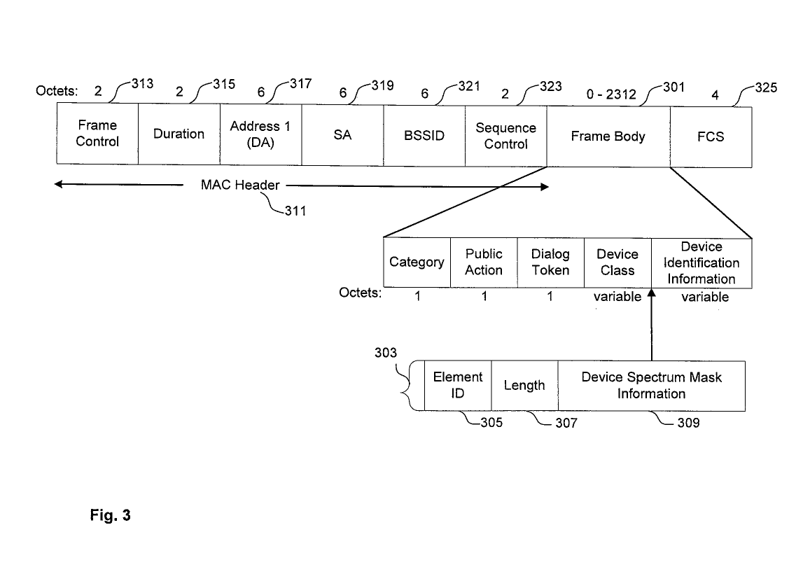

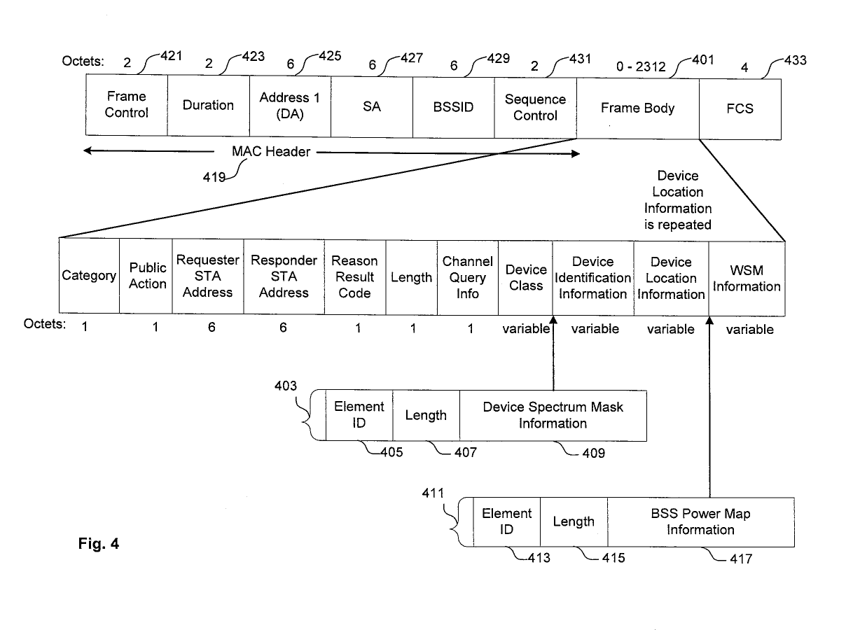

Also according to the first illustrative example, the slave WSD provides information about its emission mask characteristics. The slave WSD includes such information in one or more of the association and/or reassociation request frame and at least one of the GDC enablement request and channel availability query frames as shown in FIGS. 3 and 4. The emission mask characteristics are represented by using one or more of a spectrum mask descriptor element (e.g., an 802.11af spectrum mask descriptor element), a class and/or category of spectrum mask that categorizes different masks required for different categories of devices (e.g. fixed vs. portable/mobile) and/or for different regulations, and a generic representation (e.g., in accordance with IEEE 802.11-11/1624r0).

Shown in FIG. 3 is an exemplary format for a GDC enablement request including within frame body 301 additional element 303 having element ID 305, length 307, and device spectrum mask information 309. Also shown in FIG. 3 are MAC header 311 elements frame control 313, duration 315, address 1 destination address (DA) 317, source address (SA) 319, basic service set identification (BSSID) 321, and sequence control 323. Further shown in FIG. 3 is frame check sequence (FCS) 325.

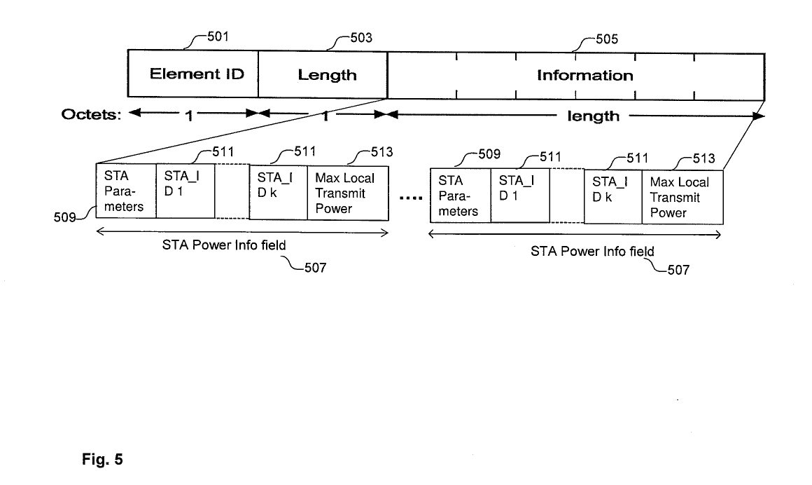

Shown in FIG. 4 is an exemplary format for a channel availability query frame including within frame body 401 additional element for device spectrum mask information 403 having element ID 405, length 407, and device spectrum mask information 409. The element 403 for device spectrum mask information is included in the channel availability query frame while the element for BSS power map Information is included in the response to the channel availability query frame (see, for instance, FIG. 5 hereinbelow). The same action frame format is used for the channel availability query frame and the response to the channel availability query frame, with respective reason result code information indicating which of device spectrum mask information and BSS power map information is being conveyed. See, for instance, element for device spectrum mask information 403 and element for BSS power map information 411. Included in element 403 are element ID 405, length 407, and device spectrum mask information, while included in element 411 are element ID 413, length 415, and BSS power map information 417. Also shown in FIG. 4 are MAC header 419 elements frame control 421, duration 423, DA 425, SA 427, BSSID 429, and sequence control 431. Further shown in FIG. 4 is FCS 433.

Further according to the first illustrative example, based on a slave WSD's permitted maximum regulatory transmit power level and the slave WSD's power capability values and/or emission mask characteristics, the master WSD determines the local maximum transmit power level for the slave WSD in order to ensure behaviors such as the device not causing harmful interference under the constraint of the maximum regulatory power level and/or the device not causing hidden node and/or coexistence problems to other stations by transmitting in a very low power or very high power.

The hidden node problem arises in networks (e.g., in WLAN networks) when transmissions of a WSD are not detectable by another WSD due to the WSDs being located out of range of each other. Possible causes for this include dissimilar maximum transmit power allocations amongst the two WSDs as transmissions from a low power WSD are potentially not heard from another WSD when that other WSD is located far away from the first WSD and/or where objects obstruct the signal path between the first WSD and the other WSD. The hidden node problem tends to cause difficulties in carrier sense multiple access with collision avoidance (CSMA/CA) channel access such as that used in WLAN networks where assumption is made that each WSD is able to hear signals from other WSDs for sensing the medium before attempting transmissions and avoid collisions.

Still further according to the first illustrative example, according to one exemplary implementation in determining the local maximum transmit power level P_{Loc}^{(k)} for a slave WSD the master WSD sets P_{Loc}^{(k)} such that P_{Loc}^{(k)}≦P_{Reg}^{(k)} and Pₘᵢₙ^{(k)}≦P_{Loc}^{(k)}≦Pₘₐₓ^{(k)}. Moreover, the master WSD optionally sets P_{Loc}^{(k)} based on its own algorithm within these constraints to optimize aspects such as one or more of coexistence problem minimization and network throughput maximization in its BSS. In some regulatory domains, the master WSD is responsible for ensuring that out of band emission from its slave WSDs meet applicable regulatory requirements for which the local power allocations depend on slave WSD emission mask information. Further, the local maximum transmit power P_{Loc}^{(k)} is optionally periodically computed by the master WSD such as when the master WSD obtains new information from the WSDB/GDB subsequent to the end of a current validity period.

Still further according to the first illustrative example, local maximum transmit powers for slave WSDs are optionally culled by the master WSD from a limited pool of values such that there is not necessarily a unique local maximum transmit power for each slave WSD. According to a non-limiting example, a master WSD managing ten slave WSDs selects for each such slave WSD a local maximum transmit power culled from a pool of only seven values. The members of the pool are in one alternative chosen by the master WSD. As another alternative the pool is be populated by the master WSD's manufacturer. Such employment of a limited pool of values potentially allows the master WSD to more effectively manage the possible sets of local transmit power levels (e.g., due to reduced memory requirements and/or processing requirements). In accordance with the foregoing, according to one exemplary implementation P_{Loc}^{(k)} is such that P_{Loc}_{_{k=1 . . . K}}^{(k)}ε{P_{Loc}^{(m)}}, m=1, . . . , M, where M≦K with M being the quantity of pool members and K being the quantity of slave WSDs. The circumstance of M<K indicates the quantity of pool value members being fewer than the quantity of slave WSDs while the circumstance of M=K indicates the quantity of pool members being equal to the quantity of slave WSDs.

Also according to the first illustrative example, it is noted that according to at least IEEE 802.11 TPC procedures a single regulatory limit on maximum transmit power is employed for all slave WSDs managed by a corresponding master WSD. In contrast, the first illustrative example supports there not being a single regulatory limit on maximum transmit power employed for all slave WSDs managed by a corresponding master WSD. As such, in determining the maximum local transmit power level corresponding to each of its managed slave WSDs at a given time the master WSD, in absence of such a single regulatory limit, tracks various parameters for each of its managed slave WSDs such as permitted EIRP power level. Such parameters potentially have certain validity times and/or change dynamically.

As a second illustrative example of master WSD transmit power management functionality, the master WSD advertises or otherwise communicates the local maximum transmit power levels determined for the slave WSDs that it manages. The master WSD optionally also advertises or otherwise communicates the one or more regulatory maximum transmit power levels for the slave WSDs that it manages. A given slave WSD employs some or all of that information in its operation. There is not necessarily a single regulatory maximum transmit power level for all slave WSDs managed by a master WSD. Hence, the option of advertising the regulatory and local maximum transmit power levels by using country and power constraint elements in beacon and probe response frames is ill-suited. Two exemplary implementations will be discussed.

According to the first exemplary implementation a new element having the possible format illustrated by FIG. 5 is employed. Alternately or additionally, existing elements such as the country element and the power constraint element are extended. Such a new or extended element includes all regulatory maximum transmit power levels, all local maximum transmit power levels, or both for all slave WSDs managed by a master WSD. Employing such new and/or extended elements allows the master WSD to advertise such information to the slave WSDs that it manages. As one alternative, the information is communicated by including the information in the beacon and probe response frames in accordance with current specifications (e.g., IEEE 802.11 specifications). Alternately or additionally, the information is communicated in a periodic manner within the corresponding time validity information. Still further, the regulatory maximum transmit power levels, local maximum transmit power levels, or both are alternately or additionally included in association and/or reassociation responses, and/or in enablement responses to a new slave WSD joining the group of slave WSDs managed by a master WSD (e.g., joining the master WSD's BSS) such that the new slave WSD is able to utilize power constraints of the other slave WSDs managed by the master WSD.

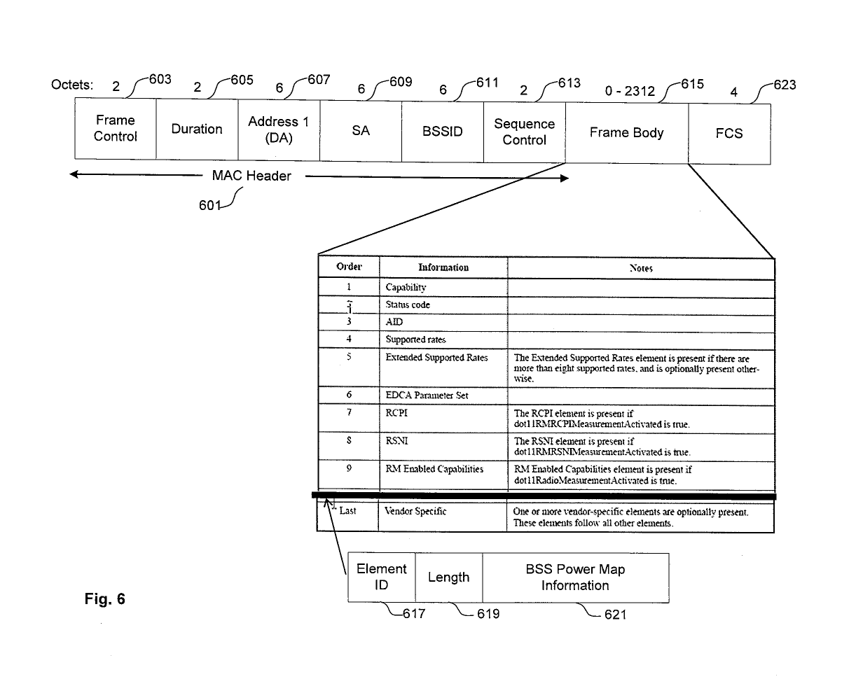

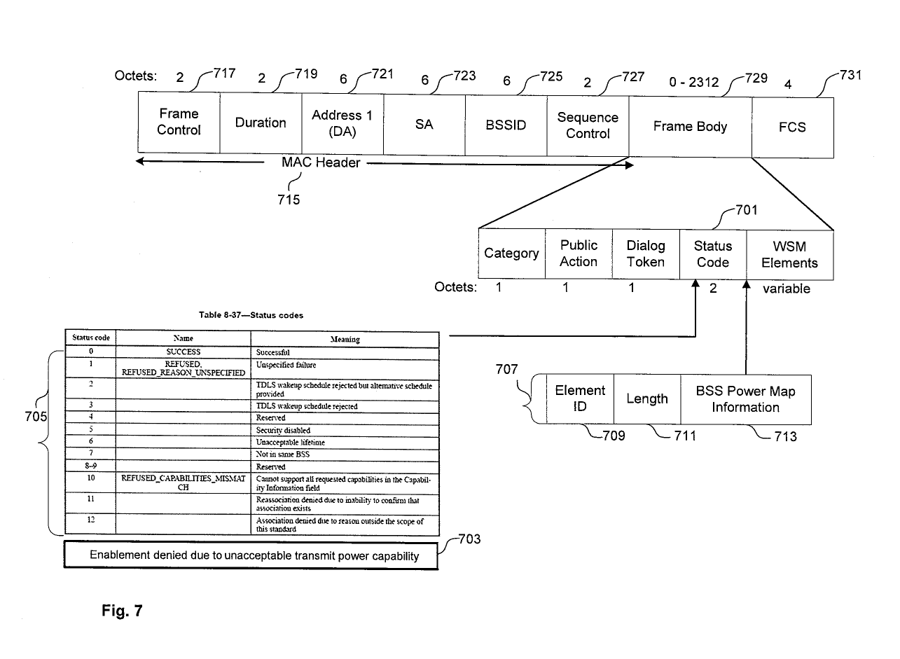

According to the second exemplary implementation, the master WSD sets a single global regulatory maximum transmit power level (e.g., for a BSS for a specific operating channel) for all of the slave WSDs that it manages yet assigns slave-WSD-specific local maximum transmit power levels. The single global regulatory maximum transmit power level is advertised by setting the respective field in the country element. The slave-WSD-specific local maximum transmit power levels is communicated in a broadcast frame and/or sent to each slave WSD in unicast manner. More specifically regarding dispatch of the slave-WSD-specific local maximum transmit power levels, a new element as illustrated in FIG. 5 is created to provide the map of local power levels allocated to all managed slave WSDs. The new element is inserted into beacon and/or probe response frames. Alternatively or additionally, such new element is sent to each slave WSD by inserting the element into the association and/or reassociation response frames as shown in FIG. 6, into the enablement response and/or channel availability query response frames as illustrated in FIGS. 4 and 7, and/or into part of any other unicast frame such as one created for the purpose. Selection of the single global regulatory maximum transmit power level is such that the single global regulatory maximum transmit power level is set to be the highest one of the regulatory maximum transmit power levels corresponding to the managed slave WSDs. As such, the single global regulatory maximum transmit power level is according to one exemplary implementation set according to P_{Reg}^{global}=max{P_{Reg}⁽¹⁾, . . . , P_{Reg}^{(K)}} where K is quantity of slave WSDs.

FIG. 5 sets forth an exemplary BSS power map IE. Shown in FIG. 5 are octets 501 and 503 which are optionally in the IEEE 802.11 common IE format of one octet Element ID field to uniquely indicate element type and one octet Length field to indicate the number of octets in the information field 505. Alternative implementation is possible including indication of the element type not involving unique identification.

Contained in information part 505 are one or more STA power information fields 507. Contained in each STA power information field 507 is a one octet STA parameters subfield 509 that indicates the number of STAs (N_STA) in the corresponding power category and any flag set for the use of transmit power by these STAs. As an example, six bits are used to represent N_STA information, and rest of the bits are used to indicate low power protection category (e.g., LP_Protection category) flags and/or (high power protection category (e.g., HP_Protection category) flags. Contained in each of one or more STA_ID subfields 511 is a two octet association identifier for each STA for which this field applies. Contained in each of maximum local transmit power subfield 513 is the maximum transmit power (e.g., expressed in dBm) allowed in a corresponding current operating channel for the STAs listed within the field.

Shown in FIG. 6 is an exemplary format for an association and/or reassociation response applicable where the AP such as slave WSD 901 (discussed herein below), which is not the master WSD of a WSD such as one of slave WSDs 903 (discussed herein below), includes the BSS power map information element in the association response frame and/or reassociation response frame. Shown in FIG. 6 are MAC header 601 elements frame control 603, duration 605, address 1 DA 607, SA 609, BSSID 611, and sequence control 613. Further shown in FIG. 6 are frame body 615 aspects element ID 617, length 619, and BSS power map information 621. Also shown in FIG. 6 is FCS 623.

FIG. 7 sets forth an exemplary GDC enablement response. The status code field 701 is used to indicate the success or failure of a requested operation by the management frame. To indicate failure of the enablement due to unsatisfactory permitted regulatory power level and/or power capability, a new status code 703 is added to the list of current status code field values 705. Further included in the GDC enablement response are element for BSS Power Map Information 707 including element ID 709, length 711, and BSS power map information 713. Also shown in FIG. 7 are MAC header 715 elements frame control 717, duration 719, address 1 DA 721, SA 723, BSSID 725, and sequence control 727. Additionally shown in FIG. 7 are frame body 729 including status code 701 and FCS 731.

As a third illustrative example of master WSD transmit power management functionality, the master WSD sets low power protection rules and/or high power protection rules based on one or more of the set of regulatory maximum transmit power levels and the set of local maximum transmit power levels for the slave WSDs managed by the master WSD (e.g., slave WSDs within the a BSS of the master WSD). Each slave WSD managed by a master WSD is subject to at least one of a certain regulatory maximum transmit power level and a certain local maximum transmit power level. Under various circumstances, there is great variance among the maximum transmit power levels to which such slave WSDs are subjected. As a non-limiting example slave WSDs with higher quality of emission mask implementation and/or the capability to geo-locate with greater accuracy are likely to get higher regulatory maximum transmit power levels and/or local maximum transmit power levels than less capable slave WSDs. As another a non-limiting example slave WSDs of certain device types are allocated higher regulatory maximum transmit power levels and/or local maximum transmit power levels than slave WSDs of other device types. Such device type distinctions include one or more of fixed versus portable indoor versus outdoor. Moreover, the regulatory maximum transmit power level and/or the local maximum transmit power level of the master WSD are often of particular importance due to the prominent role of the master WSD. Examples of such prominence include the master WSD's provision of geo-location information and enablement of joining slave WSDs.

Also according to the third illustrative example, due to the variance among the maximum transmit power levels to which the slave WSDs are subjected and/or the maximum transmit power levels of the master WSD, the transmissions from certain WSDs are likely to cause a higher degree of problematic behavior than other WSDs. One example of such problematic behavior is that of hidden nodes, a phenomenon that arises due to circumstances including one or more WSDs having maximum transmit power levels that are low relative to the maximum transmit power levels of other WSDs. Another example of such problematic behavior is that of interference, a phenomenon that arises due to one or more WSDs having maximum transmit power levels that are high relative to the maximum transmit power levels of other WSDs. The following master WSD functionality endeavors to avoid and/or mitigate such problems.

Additionally according to the third illustrative example, low power protection rules are employed to combat problematic behavior arising due to low relative maximum transmit power levels such as the noted hidden node problem. As such, a master WSD computes a threshold for low transmit power levels such that all slave WSDs violating the threshold by using transmit power lower than this value—due to the allocated regulatory or local maximum transmit power level and/or due to some other reasons—are mandated to use low power protection rules. A given WSD operates in accordance with that mandate.

Also according to the third illustrative example, in order to mandate that the slave WSDs managed by the master WSD are required to use such low power protection rules the master WSD sets a field (e.g., the LP_Protection_Required field) to a particular value (e.g., to 1) in an element (e.g., the GDC operation element) broadcasted to the slave WSDs that it manages. Such element is broadcasted via the beacon and/or probe response. In connection with this the master WSD optionally keeps one or more corresponding global management information base (MIB) variables with respect to the slave WSDs that it manages. The master WSD decides to activate the low power protection rules when it detects at least one active slave WSD having maximum transmit power level below the threshold, and/or based on other additional criteria such as observed network performance. The master WSD optionally is able to activate fewer than all of multiple low power protection rules, and to specify to slave WSDs which ones of multiple low power protection rules are to be activated.

Further according to the third illustrative example, one possible low power protection rule is to mandate exchange of request to send (RTS) and clear to send (CTS) frames before any data transmission. This low power protection rule serves to disallow initiation of low power packets unless the proper network allocation vector (NAV) value is distributed amongst the slave WSDs that the master WSD manages. Implementation of this rule includes appropriate slave WSDs being notified of assignment to a low power category (e.g., to the low power category). Such category assignment notification involves a slave WSD learning via BSS power map information that it belongs to the low power category. When a slave WSD detects that the rule has been activated and recognizes that it belongs to the low power category, the slave WSD initiates the frame exchange sequence by first transmitting an RTS frame to the destination WSD where the duration field of the frame set to the value required for the slave WSD's data transfer. Moreover, this rule acts to disallow one or more of unprotected transmissions and the use of CTS-to-self frames for NAV value distribution. As unprotected transmissions and CTS-to-self frames are generally considered to be less robust against hidden nodes and collisions than RTS/CTS, especially when they are transmitted by a low power device, such disallowment is potentially beneficial.

Also according to the third illustrative example, another possible low power protection rule is to mandate that slave WSDs using transmit power lower than the threshold value indicate employment of low power transmission mode (e.g., by a flag and/or actual power level information) in transmitted RTS frames and/or in the CTS frames transmitted in response to such RTS frames. Along with this rule is optionally an additional rule which disallows a WSD from responding with CTS when the corresponding RTS indicates the RTS to have been sent from a slave which has been assigned to the low power category (e.g., as discussed above). Depending upon factors such as one or more of observed network performance and status of slave WSDs managed by the master WSD, these additional measures are optionally implemented in addition to the above-discussed rule regarding mandated RTS/CTS exchange. Moreover, these additional measures potentially serve to facilitate the master WSD's performance one or more of monitoring network use, mandating that the slave WSDs managed by the master WSD are required to use low power protection rules, and implementing the exemplary specific service time allocation rule which will now be discussed.

Still further according to the third illustrative example, yet another possible low power protection rule is to mandate that the slave WSDs that the master WSD manages operate in view of the ability for the master WSD to allocate a specific service time for low power WSDs during which high power WSDs are not allowed to transmit unless such transmission is at low power. In some implementations, it is possible to improve network performance in the presence of low power WSDs by allowing such WSDs to enjoy such exclusive service periods during which the low power WSDs will not get interfering transmissions from devices not transmitting at low power. Two exemplary implementations will be discussed.

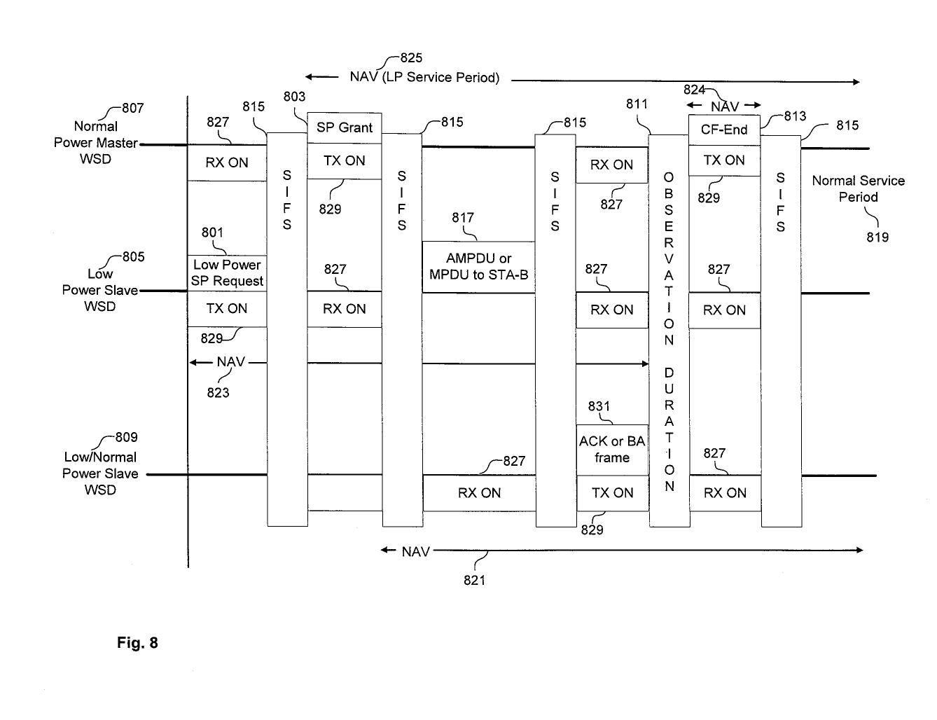

Shown in FIG. 8 is an exemplary low power protection rule implementation. The first exemplary implementation, which employs enhanced distributed channel access (EDCA), is shown in FIG. 8. Dedicated low power service period (SP) request frame 801 and SP grant frame 803 are exchanged for starting a protected service period using EDCA contention. As shown in FIG. 8 low power slave WSD 805 desirous of enjoying a low power WSD-specific service time indicates such via low power SP request frame 801. Normal power master WSD 807 grants the request and indicates such via SP Grant frame 803. Responsive to SP grant frame 803 low power slave WSD 805 is able to opt to transmit within the exclusive service period. Responsive to SP grant frame 803 low/normal power slave WSD 809 abstains from transmissions that are not low power during the exclusive service period. Further responsive to SP grant frame 803 low/normal power slave WSD 809 is able to opt to transmit within the exclusive time period at low power. Normal power master WSD 807 is able to allocate more transmission opportunity (TXOP) time than requested by low power slave WSD 805 when there are more such WSDs available in the network. After monitoring of the medium idle time 811, normal power master WSD 807 terminates the service period by dispatching CF-End frame 813.

Also according to the first exemplary implementation, additionally depicted in FIG. 8 are short interframe spaces (SIFSs) 815, media access control protocol data unit aggregation (AMPDU) and/or media access control protocol data unit (MPDU) dispatch 817 to low/normal power slave 809, normal service period 819, NAV value indications 821, 823, and 824, low power service period NAV value indication 825, reception (RX) on periods 827, transmission (TX) on periods 829, and acknowledgment (ACK) or block acknowledgment (BA) frame 831. NAV values 821, 823, and 825 are conveyed to master WSD 807's managed WSDs such as low power slave WSD 805 and low power/normal power slave WSD 809 using SP grant frame 803 and/or the existing CTS-to-self frame.

According to the second exemplary implementation, a master WSD supporting hybrid coordination function controlled channel access (HCCA) alternatively or additionally reserves a contention free period (CFP) so as to allocate the specific service time for low power WSDs during which high power WSDs are not allowed to transmit. The master WSD then during the CFP polls the low power WSDs to allow the TXOP.

According to the third illustrative example, high power protection rules are employed to combat problematic behavior arising due to high relative maximum transmit power levels such as the noted interference problem. The high power protection rules are capable of preventing interference to a neighboring co-channel BSS. The high power protection rules are optionally activated in response to receipt of a request to prevent such interference from a network management entity such as a 802.11af or other registered location secure server (RLSS), or a 802.19.1 or other coexistence manager (CM). As such, a master WSD computes a threshold for high transmit power levels such that all slave WSDs violating the threshold by using transmit power higher than this value—when such levels are allowed by the allocated regulatory or local maximum transmit power level—are mandated to use high power protection rules. A given WSD operates in accordance with that mandate.

Further according to the third illustrative example, in order to mandate that the slave WSDs managed by the master WSD are required to use such high power protection rules the master WSD sets a field (e.g., the HP_Protection_Required field) to a particular value (e.g., to 1) in an element (e.g., the GDC Operation element) broadcasted to the slave WSDs that it manages. Such element is broadcasted via the beacon and/or probe response. In connection with this the master WSD optionally keeps one or more corresponding global MIB variables with respect to the slave WSDs that it manages. The master WSD decides to activate the high power protection rules when it detects at least one active slave WSD having maximum transmit power level above the threshold, and/or based on other additional criteria such as observed network performance. The master WSD optionally is able to activate fewer than all of multiple high power protection rules, and to specify to slave WSDs which ones of multiple high power protection rules are to be activated.

Additionally according to the third illustrative example, one possible high power protection rule is restrict high-power WSDs to either use lower transmit powers or stop transmission during a known service time allocated for lower power WSDs. Implementation of this rule is optionally in conjunction with the above-discussed low power protection rule regarding allocation of specific service time for low power WSDs during which high power WSDs are not allowed to transmit unless such transmission is at low power. When a WSD that belongs to a high power category (e.g., to the high_power category) detects the above-discussed SP grant frame transmitted by the master WSD, the high power category WSD abstains from transmissions that are not low power until the set NAV expires or the above-discussed CF-end frame resets the NAV value. The WSD belonging to the high power category is notified of assignment to that category in a manner involving the WSD learning of such via BSS power map information.

Also according to the third illustrative example, another possible low power protection rule is to mandate that a slave WSD belonging to the high power category perform TPC request/response frame exchange with an intended peer slave WSD. When such a slave WSD desirous of communication with an intended peer slave WSD detects that the rule has been activated and recognizes that it belongs to high power category (e.g., as discussed above), the desirous slave WSD initiates TPC request/response procedure before initial data transmission to the peer slave WSD. Potential benefits of this rule include minimizing power level based on link margin information and minimizing potential interference in adjacent networks from high power slave WSDs desirous of communication with a peer slave WSD by limiting the transmit power to reach that peer slave WSD.

As a fourth illustrative example of master WSD transmit power management functionality, the master WSD determines and advertises a default transmit power level. A given slave WSD operates in accordance with that default transmit power level. In one aspect the default transmit power level is to be employed by new slave WSDs, seeking to join the group of WSDs managed by the master WSD, in initial contact with the master WSD when seeking enablement. In an alternative or additional aspect the default transmit power level is to be employed by slave WSDs, seeking to rejoin the group of WSDs managed by the WSD, in post expiratory contact with the master WSD when seeking reenablement subsequent to the time validity of permitted regulatory parameters expiring. The master WSD sets the default power level as the minimum of the all known regulatory limits for the slave WSDs that the master WSD manages. According to one exemplary implementation, the master WSD sets the default power level as the default power level allocated from a database (e.g., a WSDB/GDB) for slave WSDs not able to send geo-location information to the master WSD. Potential benefits of this functionality include ensuring that communication between a slave WSD and a master WSD is started at a power level that is safe to prevent harmful interference under circumstances including the discussed initial contact and the discussed post expiratory contact. So seeking appropriate power level is applicable at least in connection with the Ofcom model.

As a fifth example of master WSD transmit power management functionality, the master WSD performs association and enablement in a manner taking into account permitted regulatory power level and/or transmit power capability. The master WSD's performance of association and enablement is such that the master WSD rejects association and/or enablement of a WSD based on the WSD's permitted regulatory power level and/or one or more of its power capability information and emission mask characteristics. The master WSD subsequently indicates that rejection in the enablement response by a new status code (see FIG. 7). Alternately or additionally, the master WSD deenables a managed slave WSD in the case where the slave WSD transmits using power levels violating one or more protection rules set by the master WSD. Potential benefits of this functionality include one or more of performance level maintenance and protection from hidden node problems. Moreover, this functionality is applicable in implementations where, perhaps due to security constraints, the association/authentication process is completed before sending the enablement request, and the enablement request/response procedure assumes such completion. It is noted that the foregoing is further applicable to reassociation.

Example embodiments of the invention include an apparatus, comprising:

means for obtaining, at a white space device, a plurality of managed white space device regulatory maximum transmit power levels;

means for calculating, at the white space device, a plurality of managed white space device local maximum transmit power levels, wherein the calculation takes into account one or more of a plurality of managed white space device power capabilities and a plurality of managed white space device emission mask characteristics;

means for determining to transmit, from the white space device, the calculated plurality of managed white space device local maximum transmit power levels; and

means for performing, at the white space device, one or more of:
administrating one or more managed white space device power protection rules;
setting a managed white space device default transmit power level; and
rejecting, based on one or more of the managed white space device regulatory maximum transmit power levels and the managed white space device power capabilities, managed white space device association and/or enablement.

Example embodiments of the invention further include an apparatus, comprising:

means for determining to transmit, from a managed white space device, device information;

means for determining to transmit, from the managed white space device, power capability information and/or emission mask characteristics;

means for receiving, at the managed white space device, a local maximum power transmit level of said managed white space device, wherein the white space device local maximum power transmit level is received via a plurality of managed white space device local maximum power transmit levels, and wherein the plurality of managed white space device local maximum power transmit levels are white space device-calculated;

means for receiving, at the managed white space device, one or more of:
mandate that the managed white space device use one or more managed white space device power protection rules; and
a default transmit power level; and

means for operating, at the managed white space device, in accordance with one or more of the local maximum power transmit level of said managed white space device, the mandate, and the default transmit power level.

### Transmit Power Management—Slave White Space Device (WSD) Functionality

Exemplary slave WSD transmit power management functionality applicable in handling multiple levels of transmit power constraints will now be discussed.

According to an illustrative example, a slave WSD in one aspect is managed by a master WSD yet in another aspect manages one or more slave WSDs. Moreover, it is possible to split among multiple WSDs responsibilities for managing a WSD set. According to one exemplary implementation, certain management responsibilities such as enablement and obtaining regulatory specific operating parameters for that set of nodes fall to a first WSD while other management responsibilities for that set of nodes—potentially including acting as an AP—fall to a second WSD. Likewise it is possible to split between multiple WSDs the management responsibilities discussed above relating to transmit power.

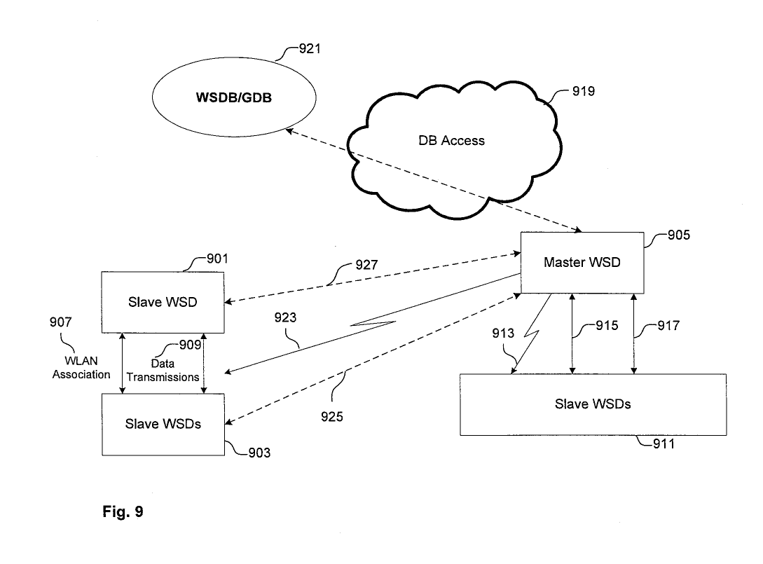

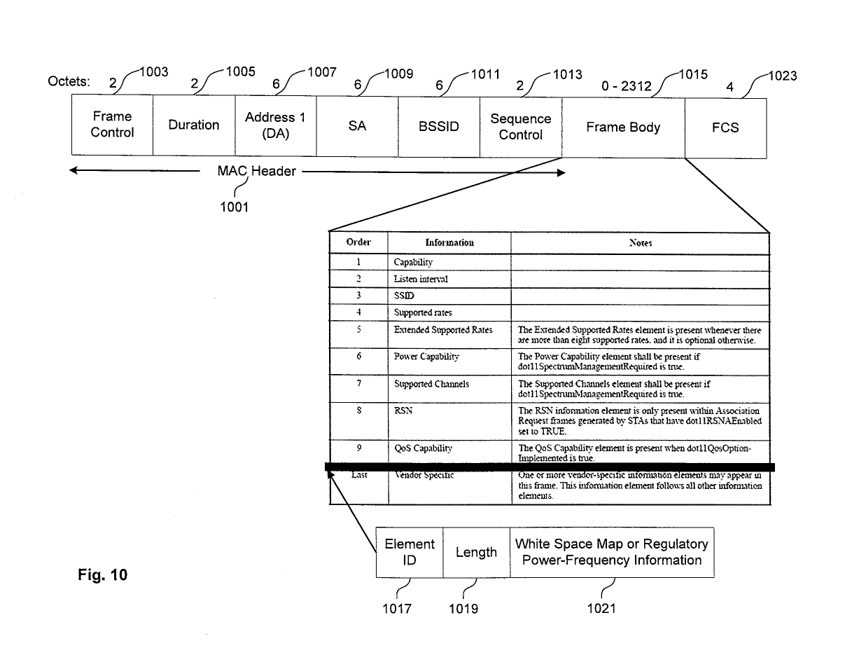

Shown in FIG. 9 is exemplary slave WSD transmit power management functionality. FIG. 9 depicts slave WSD 901 operating as an AP to slave WSDs 903 of its BSS, but slave WSDs 903 communicating to master WSD 905 for enablement and in order to obtain regulatory specific operating parameters. The management responsibilities relating to transmit power are split between master WSD 905 and slave WSD 901. Slave WSD 901 is responsible for local power management for slave WSDs 903 while master WSD 905 is responsible for regulatory power management of slave WSDs 903. In connection with that local power management responsibility, slave WSD 901 obtains the regulatory transmit power limits of each of slave WSDs 903. For this purpose the slave WSDs 903 send their regulatory power limits to the slave WSD 901 during the association process. This information is according to one exemplary implementation included in one or more of in to the association and/or reassociation request frames. Alternatively or additionally this information is included in a separate frame created for the purpose (see FIGS. 6 and 10). In addition, any changes to regulatory power constraints in the operating channels of any of slave WSDs 903 (e.g., during getting updated information after expiry of current time validity period) are reported to slave WSD 901. In one exemplary implementation, slave WSDs 903 update slave WSD 901 with any changes autonomously to notify these parameters without any message request coming from slave WSD 901. Alternatively or additionally slave WSD 901 periodically polls slave WSDs 903 for currently valid regulatory limits. It is noted that the foregoing is further applicable to reassociation.

Shown in FIG. 10 is a possible format for an association and/or reassociation request employable to convey permitted power and/or frequency usage. Added to fields carried during an association request frame and/or a reassociation request frame are a new information element (e.g., a regulatory power frequency map information element) and/or a reused existing information element such as a white space map (WSM). Such addition is optional. For instance, such addition is only performed to send to an AP such as slave WSD 901 which is not the master WSD of a WSD such one of slave WSDs 903 sending these frames. Contained in the employed information element is information for one or more current operating channels. Alternately or additionally contained in the employed information element is one or more of information about some or all available frequency ranges and respective maximum power levels (e.g., regulatory maximum power levels). The addition of such frequency range and/or such maximum power level information is potentially beneficial for determining any changes to operating channel of the BSS in future. That which is set forth in FIG. 10 is employable in addressing needs which arise in application of the Ofcom database model which are not met by 802.11af (e.g., by the 802.11af WSM element). Shown in FIG. 10 are MAC header 1001 elements frame control 1003, duration 1005, address 1 DA 1007, SA 1009, BSSID 1011, and sequence control 1013. Further shown in FIG. 10 are frame body 1015 aspects element ID 1017, length 1019, and white space map or regulatory power frequency information 1021. Also shown in FIG. 10 is FCS 1023.

Further according to the example of FIG. 9, in contrast to merely having slave WSD 901 obtain the regulatory parameters of its use from master WSD 905 and having each of slave WSDs 903 obtain the same from master WSD 905 such as during their own enablement and channel query exchange with master WSD 905, slave WSDs 903 being be managed in part by slave WSD 901 itself yields potential benefits including slave WSD 901 being able to coordinate its own network and avoid hidden node issues.

Further shown in FIG. 9 are WLAN association communications 907 and data transmissions 909 between slave WSD 901 and slave WSDs 903. Additionally shown in FIG. 9 are slave WSDs 911 hearing enabling signal 913, enablement and channel query communications 915 between master WSD 905 and slave WSDs 911, continuance of TVWS signal receipt 917 by slave WSDs 911 and/or master WSD 905 (e.g., in accordance with receipt intervals each of fewer than 5 seconds in duration), and database access communication 919 between master WSD 905 and WSDB/GDB 921. While FIG. 9 depicts continuance of TVWS signal receipt, TVWS signal receipt, in the alternative or in addition, regards one or more new signals. Still further shown in FIG. 9 are slave WSD 901 and/or one or more of slave WSDs 903 hearing a TVWS signal 923 (e.g., in accordance with receipt intervals each of fewer than 5 seconds in duration), enablement and channel query communications 925 between slave WSDs 903 and master WSD 905, and enablement and channel query communications 927 between slave WSD 901 and master WSD 905. As a non-limiting example, master WSD 905 handles regulatory power management for slave WSD 901 and/or one or more of slave WSDs 903, while slave WSD 901 handles local power management for one or more of slave WSDs 903 of its BSS.

At least in a circumstance such as that depicted in FIG. 9, alternative terms for master WSD 905 are “serving master WSD” and “enabling AP,” and alternative terms for slave WSD 903 are as “slave AP” and “dependent AP.”

### Location Information Estimation Functionality

Exemplary location information estimation functionality will now be discussed.

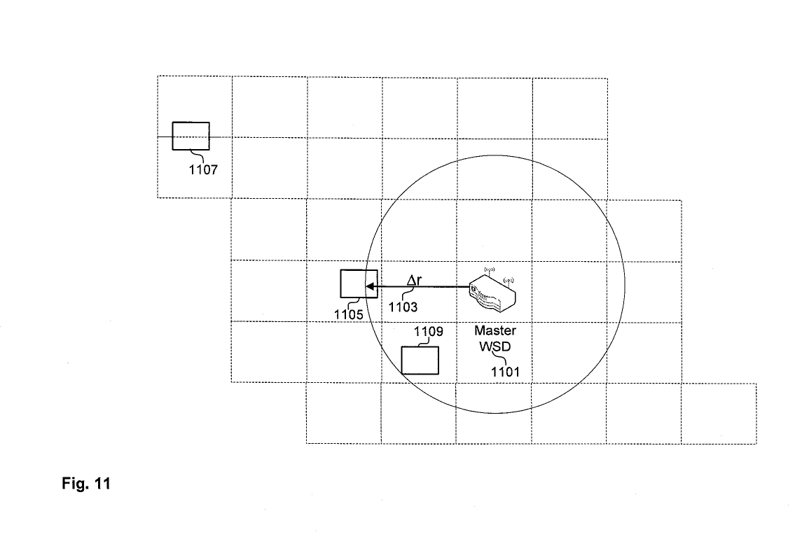

As a first illustrative example of such functionality, a master WSD estimates the relative range and/or relative direction of a slave WSD that it manages. FIG. 11 shows exemplary location information estimation functionality. As shown in FIG. 11 timing measurement procedures (e.g., 802.11v timing measurement procedures) are used by master WSD 1101 to determine the relative range (Δr) 1103 of a slave WSD from the master WSD 1101. Optionally, by knowledge of the directivity and/or angular orientation of one or more of the antennas of itself and a slave WSD, master WSD 1101 determines the relative direction (Δφ) of that slave WSD. Also shown in FIG. 11 are estimated location 1105 of a non self-geo-locating slave WSD, estimated location 1107 of a further non self-geo-locating slave WSD, and known location 1109 of a self-geo-locating WSD.

Further according to the first illustrative example, the slave WSD corresponding to known location 1109, the slave corresponding to estimated location 1105, and the slave corresponding to estimated location 1107 belong to different slave WSD categories and get different power levels. The slave WSD corresponding to known location 1109 gets power level P1, the slave corresponding to estimated location 1105 gets power level P2, and the slave corresponding to estimated location 1107 gets power level P3 where P3<P2<P1. The determination of estimated location 1107 takes into account relative range (Δr) 1103.

As a second illustrative example of location information estimation functionality, the master WSD estimates the absolute geo-location of a slave WSD that it manages. The absolute geo-location of the slave WSD is derived by the master WSD using its own known geo-location, the relative range and/or relative direction of the slave WSD, and/or any other available direction information. According to one exemplary implementation, the master WSD has as its own known geo-location in terms of (x, y, Δx, Δy) where x is latitude, Δx is latitude uncertainty, y is longitude value, and Δy is longitude uncertainty and derives the geo-location of the slave WSD as (x, y, Δx+Δr, Δy+Δr). A WSD having additional information such as antenna radiation pattern information allows for its relative location to be estimated more accurately.

Geo-location information is specifiable in a number of ways. As one example, geo-location information is represented using binary Location Configuration Information (LCI) format such as set forth by RFC 6225 with specification of latitude, longitude, altitude, and their respective uncertainty values. As another example, geo-location information is represented using upper layer extended formats such as XML.

As a third illustrative example of location information estimation functionality, the relative range and/or relative direction information of the slave WSD is used by the master WSD while communicating with the WSDB/GDB. One option involves the master WSD passing to the WSDB/GDB the relative range and/or relative direction information of the slave WSD, and the WSDB/GDB interpreting that information. Optionally, such interpretation of that information is performed by the WSDB/GDB only when full location coordinates for the slave WSD are not available. Another option involves the master WSD estimating the absolute geo-location of a slave WSD that it manages, in the fashion discussed above, and passing the estimated absolute geo-location to the WSDB/GDB for processing. Included with the estimated the absolute geo-location is optionally indication that the passed information represents only an estimate of the slave WSD's geo-location. The WSDB/GDB optionally makes use of the estimated the absolute geo-location only when full location coordinates for the slave WSD are not available.

As a fourth illustrative example of location information estimation functionality, a slave WSD indicates one or more of its geo-location capability (e.g., self geo-location capable or non-geo-locatable) and any capability to provide relative range and/or relative direction information. Such indication of capability to provide relative range optionally comes only from WSDs without self geo-location capability. Such indication is included as part of the initial enablement request frame and/or subsequent channel availability query requests.

When a slave WSD is not able to determine the location, it receives permitted operating parameters which reflect the WSDB/GDB presenting regulatory parameters determined without the benefit of slave WSD location information. As a non-limiting example, under FCC specifications the regulatory parameters are, as referenced above, assigned by the WSDB/GDB based on default parameters according to three different device types: Fixed, Personal/Portable Mode II and Personal/Portable Mode I. As another non-limiting example, under Ofcom specifications the regulatory parameters are assigned by the WSDB/GDB in a fashion where the WSDB/GDB employs computations to estimate the possible interference and coverage range of the slave WSD. These regulatory parameters determined by the WSDB/GDB without the benefit of slave WSD location information tend to be less favorable than the regulatory parameters that would have been received with the benefit of slave WSD location information. WSDs located indoors often do not have the ability to self geo-locate and therefore end up in this situation.

The regulatory parameters presented to the master WSD by the WSDB/GDB based on estimated location information received from the master WSD are potentially less favorable than the regulatory parameters that would have been received with the benefit of true slave WSD location information. However, such regulatory parameters are nevertheless likely more favorable than regulatory parameters determined by the WSDB/GDB without the benefit of any slave WSD location information. As such, employing the foregoing techniques potentially improves the likelihood of a non-self-geo-locating WSD obtaining more favorable operating parameters from the WSDB.

### Hardware and Software

The foregoing discusses computers, such as the discussed WSDs, performing a number of operations. Exemplary computers include smart cards, media devices, personal computers, engineering workstations, PCs, Macintoshes, PDAs, portable computers, computerized watches, wired and wireless terminals, telephones, communication devices, nodes servers, network access points, network multicast points, network devices, set-top boxes, personal video recorders (PVRs), game consoles, portable game devices, portable audio devices, portable media devices, portable video devices, televisions, digital cameras, digital camcorders, Global Positioning System (GPS) receivers, wireless personal servers.

Running on such computers are often one or more operating systems. Exemplary operating systems include Windows Phone (e.g., Windows Phone 7), Windows (e.g., Windows 8, Windows 7, or Windows Vista), Windows Server (e.g., Windows Server 8, Windows server 2008, or Windows Server 2003), Maemo, Symbian OS, WebOS, Linux, OS X, and iOS. Supported by optionally such computers are one or more of the S60 Platform, the .NET Framework, Java, and Cocoa.

Exemplary computers also include one or more processors operatively connected to one or more memory or storage units, wherein the memory or storage optionally contains data, algorithms, and/or program code, and the processor or processors execute the program code and/or manipulate the program code, data, and/or algorithms.

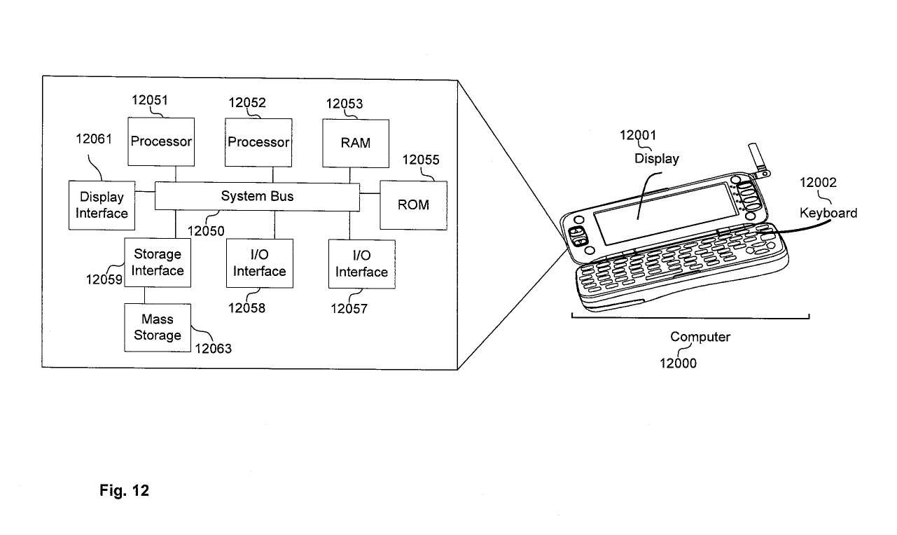

FIG. 12 shows exemplary computer 12000 including system bus 12050 which operatively connects two processors 12051 and 12052, random access memory 12053, read-only memory 12055, input output (I/O) interfaces 12057 and 12058, storage interface 12059, and display interface 12061. Storage interface 12059 in turn connects to mass storage 12063. Each of I/O interfaces 12057 and 12058 is an Ethernet, IEEE 1394, IEEE 1394b, IEEE 802.11a, 802.11af, IEEE 802.11b, IEEE 802.11g, IEEE 802.11i, IEEE 802.11e, IEEE 802.11n, IEEE 802.15a, IEEE 802.16a, IEEE 802.16d, IEEE 802.16e, IEEE 802.16m, IEEE 802.16x, IEEE 802.20, IEEE 802.22, IEEE 802.15.3, ZigBee (e.g., IEEE 802.15.4), Bluetooth (e.g., IEEE 802.15.1), Ultra Wide Band (UWB), Wireless Universal Serial Bus (WUSB), wireless Firewire, terrestrial digital video broadcast (DVB-T), satellite digital video broadcast (DVB-S), Advanced Television Systems Committee (ATSC), Integrated Services Digital Broadcasting (ISDB), Digital Multimedia Broadcast-Terrestrial (DMB-T), MediaFLO (Forward Link Only), Terrestrial Digital Multimedia Broadcasting (T-DMB), Digital Audio Broadcast (DAB), Digital Radio Mondiale (DRM), General Packet Radio Service (GPRS), Universal Mobile Telecommunications Service (UMTS), Long Term Evolution (LTE), Global System for Mobile Communications (GSM), Code Division Multiple Access 2000 (CDMA2000), DVB-H (Digital Video Broadcasting: Handhelds), HDMI (High-Definition Multimedia Interface), Thunderbolt, or IrDA (Infrared Data Association) interface.

Further according to FIG. 12 mass storage 12063 is a hard drive or flash memory Each of processors 12051 and 12052 is an ARM-based processor such as a Qualcomm Snapdragon or an x86-based processor such as an Intel Atom or Intel Core. Computer 12000 as shown in this example also includes a touch screen 12001 and physical keyboard 12002. Optionally a mouse or keypad is alternately or additionally employed. Moreover, physical keyboard 12002 is optionally eliminated.

Additionally according to FIG. 12 computer 12000 optionally includes or is attached to one or more image capture devices. Exemplary image capture devices include ones employing Complementary Metal Oxide Semiconductor (CMOS) hardware and ones employing Charge Coupled Device (CCD) hardware. One or more of the image capture devices are according to one exemplary implementation aimed towards the user. Alternately or additionally, one or more of the image capture devices are aimed away from the user. The one or more image capture devices are optionally employed by computer 12000 for video conferencing, still image capture, and/or video capture. Moreover, computer 12000 optionally includes or is attached to one or more card readers, DVD drives, floppy disk drives, hard drives, memory cards, or ROM devices whereby media containing program code—such as program code for performing the discussed operations—is optionally inserted for the purpose of loading the code onto the computer. Further, program code—such as program code for performing the discussed operations—is optionally loaded the code onto the computer via one or more of I/O interfaces 12057 and 12058, perhaps using one or more networks.

According to an exemplary implementation, executed by computers discussed herein are one or more software modules designed to perform one or more of the discussed operations. Such modules are programmed using one or more languages. Exemplary languages include C#, C, C++, Objective C, Java, Perl, and Python. Corresponding program code is optionally placed on media. Exemplary media include DVD, CD-ROM, memory card, and floppy disk.

Any indicated division of operations among particular software modules is for purposes of illustration, and alternate divisions of operation are possible. Accordingly, any operations indicated to be performed by one software module are according to an alternative implementation instead performed by a plurality of software modules. Similarly, any operations indicated to be performed by a plurality of modules are according to an alternative implementation instead be performed by a single module.

Further, any operations indicated to be performed by a particular computer such as a particular WSD are according to an alternative implementation instead performed by a plurality of computers such as by a plurality of WSDs. Moreover, peer-to-peer, cloud, and/or grid computing techniques are optionally employed. Additionally, implementations include remote communication among software modules. Exemplary remote communication techniques include Simple Object Access Protocol (SOAP), Java Messaging Service (JMS), Remote Method Invocation (RMI), Remote Procedure Call (RPC), sockets, and pipes.

Optionally, operations discussed herein are implemented via hardware. Examples of such implementation via hardware include the use of one or more of integrated circuits, specialized hardware, chips, chipsets, Application-Specific Integrated Circuits (ASICs), and Field-Programmable Gate Arrays (FPGAs). As a non-limiting example such hardware is programed to perform operations discussed herein using one or more languages such as one or more Hardware Description Languages (HDLs). Exemplary HDLs include very-high-speed integrated circuit hardware description language (VDHL) and Verilog.

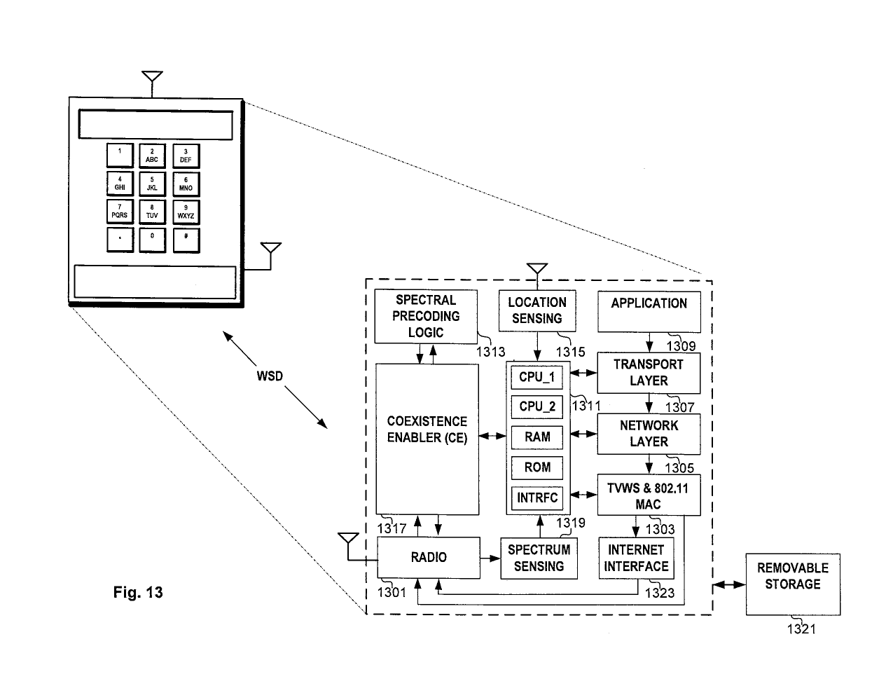

FIG. 13 is a functional block diagram according to at least one example embodiment of the invention, illustrating an example master or slave WSD. The device is configured to operate in the TVWS coexistence bands and/or additional RF spectrum bands where there are no primary user radios operating in the neighboring wireless networks, in an example embodiment of the invention.

In an example embodiment of the invention, the WSD includes a protocol stack, including the radio 1301 and the IEEE 802.11 MAC 1303, which is based, for example, on the IEEE 802.11 WLAN standard. The MAC 1303 includes integrated TV white space features. The protocol stack includes a network layer 1305, a transport layer 1307, and an application program 1309. The example WSD includes a processor 1311 that includes a dual or multi core central processing unit CPU_1 and CPU_2, a RAM memory, a ROM memory, and an interface for a keypad, display, and other input/output devices. Spectral precoding logic 1313 is included to suppress side lobe powers arising in a signal due to improperly correlated input data. A location sensor 1315, such as a GPS is included to establish the geographic location of the WSD, and the location of the WSD is reported to the network controller or coexistence manager. The coexistence enabler 1317 optionally sends resource requests to the coexistence manager. The MAC 1303 includes integrated TV white space features to communicate using the radio 1301 in channels in the TV white spaces band reallocated by the coexistence manager, without mutual interference. The spectrum sensor 1319 senses the electromagnetic environment of the WSD and reports it to the coexistence manager.

In an example embodiment of the invention, a WSDB/GDB communicates the allowed emission levels via the Internet to a coexistence manager, which forwards the allowed emission levels via the Internet to coexistence enabler 1317 in the WSD. An Internet interface 1323 may be included in the WSD to facilitate Internet communications.

In an example embodiment of the invention, the interface circuits in FIG. 13 interface with one or more radio transceivers, battery and other power sources, key pad, touch screen, display, microphone, speakers, ear pieces, camera or other imaging devices, etc. The RAM and ROM are optionally removable memory devices such as smart cards, subscriber identity modules (SIMs), wireless identification modules (WIMs), semiconductor memories such as RAM, ROM, PROMS, flash memory devices, etc., The processor protocol stack layers, and/or application program are according to an exemplary implementation embodied as program logic stored in the RAM and/or ROM in the form of sequences of programmed instructions which, when executed in the CPU, carry out the functions of example embodiments. The program logic are according to an exemplary implementation delivered to the writeable RAM, PROMS, flash memory devices, etc. of the control node or coexistence enabler and coexistence manager from a computer program product or article of manufacture in the form of computer-usable media such as resident memory devices, smart cards or other removable memory devices. Alternately, they are embodied as integrated circuit logic in the form of programmed logic arrays or custom designed ASICs. The one or more radios in the device are separate transceiver circuits or alternately, the one or more radios are a single RF module capable of handling one or multiple channels in a high speed, time and frequency multiplexed manner in response to the processor.

The WSD of FIG. 13 includes processor 1311 that optionally accesses random access memory RAM and/or read only memory ROM in order to obtain stored program code and data for use during processing. The RAM or ROM generally include removable or imbedded memories that operate in a static or dynamic mode. Further, the RAM or ROM are as illustrative examples rewritable memories such as Flash, EPROM, EEPROM, etc. Examples of removable storage media based on magnetic, electronic and/or optical technologies such as magnetic disks, optical disks, semiconductor memory circuit devices and micro-SD memory cards (SD refers to the Secure Digital standard) are shown at 1321, and optionally serve as a data input/output means. Examples of code include any interpreted or compiled computer language including computer-executable instructions. The code and/or data is optionally used to create software modules such as operating systems, communication utilities, user interfaces, more specialized program modules, etc.

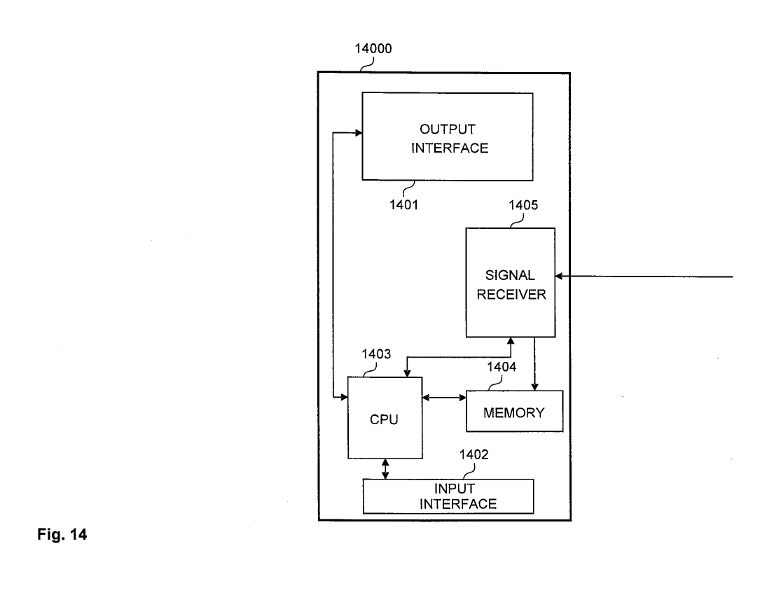

As noted, the foregoing discusses computers such as the discussed WSDs. Shown in FIG. 14 is a block diagram of a further exemplary computer, terminal 14000. Exemplary terminal 14000 of FIG. 14 includes a processing unit CPU 1403, a signal receiver 1405, and a user interface (1401, 1402). Examples of signal receiver 1405 single-carrier and multi-carrier receivers. Signal receiver 1405 and the user interface (1401, 1402) are coupled with the processing unit CPU 1403. One or more direct memory access (DMA) channels exist between multi-carrier signal terminal part 1405 and memory 1404. The user interface (1401, 1402) includes a display and a keyboard that enable a user to use the terminal 14000. In addition, the user interface (1401, 1402) includes a microphone and a speaker for receiving and producing audio signals. The user interface (1401, 1402) optionally employs voice recognition.

The processing unit CPU 1403 a microprocessor (not shown), memory 1404, and optionally software. The software is stored in the memory 1404. The microprocessor controls, on the basis of the software, the operation of the terminal 14000, such as receiving of a data stream, tolerance of the impulse burst noise in data reception, displaying output in the user interface and the reading of inputs received from the user interface. The hardware contains circuitry for detecting signal, circuitry for demodulation, circuitry for detecting impulse, circuitry for blanking those samples of the symbol where significant amount of impulse noise is present, circuitry for calculating estimates, and circuitry for performing the corrections of the corrupted data.

Still referring to FIG. 14, middleware or software implementation is optionally applied. Examples of terminal 14000 include a hand-held device such as a cellular mobile phone which includes the multi-carrier signal terminal part 1405 for receiving multicast transmission streams. Therefore, the terminal 14000 optionally interacts with service providers.

### RAMIFICATIONS AND SCOPE

Although the description above contains many specifics, these are merely provided to illustrate the invention and should not be construed as limitations of the invention's scope. For instance, various examples are articulated herein via the discussion of certain aspects. Such aspects are, themselves, merely exemplary and should not be construed as limitations of the invention's scope. Thus it will be apparent to those skilled in the art that various modifications and variations are applicable to the system and processes of the present invention without departing from the spirit or scope of the invention.

In addition, the embodiments, features, methods, systems, and details of the invention that are described above in the application are combinable separately or in any combination to create or describe new embodiments of the invention.

What is claimed is:

1. A method, comprising:
obtaining, at a white space device, a plurality of managed white space device regulatory maximum transmit power levels;
calculating, at the white space device, a plurality of managed white space device local maximum transmit power levels, wherein the calculation takes into account one or more of a plurality of managed white space device power capabilities and a plurality of managed white space device emission mask characteristics;
determining to transmit, from the white space device, the calculated plurality of managed white space device local maximum transmit power levels; and
performing, at the white space device, one or more of:
administrating one or more managed white space device power protection rules;
setting a managed white space device default transmit power level; and
rejecting, based on one or more of the managed white space device regulatory maximum transmit power levels and the managed white space device power capabilities, managed white space device association and/or enablement.

2. The method of claim 1, wherein there is a multiple white space device split of management responsibilities relating to transmit power, and wherein the plurality of managed white space device regulatory maximum power transmit levels is received from a plurality of managed white space devices.

3. The method of claim 1, wherein the power protection rule administration comprises:
computing a transmit power level threshold; and
mandating managed white space device power protection rule compliance in the case of violation of the threshold.

4. The method of claim 1, wherein the power protection rule administration comprises dispatch of a basic service set power map, wherein the basic service set power map includes bits indicating a low power protection category and/or bits indicating a high power protection category.

5. The method of claim 1, wherein the power protection rules include low power protection rules and/or high power protection rules.

6. The method of claim 1, wherein the managed white space device default transmit power level is employed in one or more of:
initial contact, seeking enablement, with the white space device; and
post expiratory contact, seeking reenablement, with the white space device.

7. The method of claim 1, wherein the rejection comprises indicating, using a status code, rejection via an enablement response.

8. The method of claim 1, further comprising:
estimating, at the white space device, one or more of managed white space device relative range and managed white space device relative direction;
employing, at the white space device, one or more of the estimated relative range and the estimated relative direction in database communication; and
receiving, at the white space device, database indication of managed white space device regulatory parameters.

9. A method, comprising:
determining to transmit, from a managed white space device, device information;
determining to transmit, from the managed white space device, power capability information and/or emission mask characteristics;
receiving, at the managed white space device, a local maximum power transmit level of said managed white space device, wherein the white space device local maximum power transmit level is received via a plurality of managed white space device local maximum power transmit levels, and wherein the plurality of managed white space device local maximum power transmit levels are white space device-calculated;
receiving, at the managed white space device, one or more of:
mandate that the managed white space device use one or more managed white space device power protection rules; and
a default transmit power level; and
operating, at the managed white space device, in accordance with one or more of the local maximum power transmit level of said managed white space device, the mandate, and the default transmit power level.

10. The method of claim 9, wherein the device information includes one or more of device identification, technology identifier, device type, location, location accuracy, and antenna characteristics.

11. The method of claim 9, wherein the power protection rules include low power protection rules and/or high power protection rules.

12. The method of claim 9, further comprising employing, at the managed white space device, the default transmit power level in one or more of:
initial contact seeking enablement; and
post expiratory contact seeking reenablement.

13. The method of claim 9, further comprising:
obtaining, at the managed white space device via master white space device communication, a regulatory maximum transmit power level of the managed white space device; and
determining to transmit, from the managed white space device via slave access point white space device communication, the regulatory maximum transmit power level.

14. An apparatus, comprising:
at least one processor; and
at least one memory including computer program code, the at least one memory and the computer program code configured to, with the at least one processor, cause the apparatus at least to perform:
obtain, at the apparatus, a plurality of managed white space device regulatory maximum transmit power levels;
calculate, at the apparatus, a plurality of managed white space device local maximum transmit power levels, wherein the calculation takes into account one or more of a plurality of managed white space device power capabilities and a plurality of managed white space device emission mask characteristics;
determine to transmit, from the apparatus, the calculated plurality of managed white space device local maximum transmit power levels; and
perform, at the apparatus, one or more of:
administrating one or more managed white space device power protection rules;
setting a managed white space device default transmit power level; and
rejecting, based on one or more of the managed white space device regulatory maximum transmit power levels and the managed white space device power capabilities, managed white space device association and/or enablement.

15. The apparatus of claim 14, wherein there is a multiple white space device split of management responsibilities relating to transmit power, and wherein the plurality of managed white space device regulatory maximum power transmit levels is received from a plurality of managed white space devices.

16. The apparatus of claim 14, wherein the power protection rule administration comprises:
computing a transmit power level threshold; and
mandating managed white space device power protection rule compliance in the case of violation of the threshold.

17. The apparatus of claim 14, wherein the power protection rule administration comprises dispatch of a basic service set power map, wherein the basic service set power map includes bits indicating a low power protection category and/or bits indicating a high power protection category.

18. The apparatus of claim 14, wherein the power protection rules include low power protection rules and/or high power protection rules.

19. The apparatus of claim 14, wherein the managed white space device default transmit power level is employed in one or more of:
initial contact, seeking enablement, with the apparatus; and
post expiratory contact, seeking reenablement, with the apparatus.

20. The apparatus of claim 14, wherein the rejection comprises indicating, using a status code, rejection via an enablement response.

21. The apparatus of claim 14, wherein the at least one memory and the computer program code are further configured to, with the at least one processor, cause the apparatus to:
estimate, at the apparatus, one or more of managed white space device relative range and managed white space device relative direction;
employ, at the apparatus, one or more of the estimated relative range and the estimated relative direction in database communication; and
receive, at the apparatus, database indication of managed white space device regulatory parameters.

22. An apparatus, comprising:
at least one processor; and
at least one memory including computer program code, the at least one memory and the computer program code configured to, with the at least one processor, cause the apparatus at least to perform:
determine to transmit, from the apparatus, device information;
determine to transmit, from the apparatus, power capability information and/or emission mask characteristics;
receive, at the apparatus, a local maximum power transmit level of said apparatus, wherein the apparatus local maximum power transmit level is received via a plurality of managed white space device local maximum power transmit levels, and wherein the plurality of managed white space device local maximum power transmit levels are white space device-calculated;
receive at the apparatus, one or more of:
mandate that the apparatus use one or more managed white space device power protection rules; and
a default transmit power level; and
operate, at the apparatus, in accordance with one or more of the local maximum power transmit level of said apparatus, the mandate, and the default transmit power level.

23. The apparatus of claim 22, wherein the device information includes one or more of device identification, technology identifier, device type, location, location accuracy, and antenna characteristics.

24. The apparatus of claim 22, wherein the power protection rules include low power protection rules and/or high power protection rules.

25. The apparatus of claim 22, wherein the at least one memory and the computer program code are further configured to, with the at least one processor, cause the apparatus to employ, at the apparatus, the default transmit power level in one or more of:
initial contact seeking enablement; and
post expiratory contact seeking reenablement.

26. The apparatus of claim 22, wherein the at least one memory and the computer program code are further configured to, with the at least one processor, cause the apparatus to:
obtain, at the apparatus via master white space device communication, a regulatory maximum transmit power level of the apparatus; and
determine to transmit, from the apparatus via slave access point white space device communication, the regulatory maximum transmit power level.

27. A computer program product comprising computer executable program code recorded on a computer readable storage medium, the computer executable program code comprising:
code for causing obtainment, at a white space device, of a plurality of managed white space device regulatory maximum transmit power levels;
code for causing calculation, at the white space device, of a plurality of managed white space device local maximum transmit power levels, wherein the calculation takes into account one or more of a plurality of managed white space device power capabilities and a plurality of managed white space device emission mask characteristics;
code for causing determination to transmit, from the white space device, the calculated plurality of managed white space device local maximum transmit power levels; and
code for causing performance, at the white space device, of one or more of:
administration of one or more managed white space device power protection rules;
setting of a managed white space device default transmit power level; and
rejection, based on one or more of the managed white space device regulatory maximum transmit power levels and the managed white space device power capabilities, of managed white space device association and/or enablement.

28. A computer program product comprising computer executable program code recorded on a computer readable storage medium, the computer executable program code comprising:
code for causing determination to transmit, from a managed white space device, device information;
code for causing determination to transmit, from the managed white space device, power capability information and/or emission mask characteristics;
code for causing receipt, at the managed white space device, of a local maximum power transmit level of said managed white space device, wherein the white space device local maximum power transmit level is received via a plurality of managed white space device local maximum power transmit levels, and wherein the plurality of managed white space device local maximum power transmit levels are white space device-calculated;
code for causing receipt, at the managed white space device, of one or more of:
mandate that the managed white space device use one or more managed white space device power protection rules; and
a default transmit power level; and
code for causing operation, at the managed white space device, in accordance with one or more of the local maximum power transmit level of said managed white space device, the mandate, and the default transmit power level.
